(19) United States
(12) Patent Application Publication
(10) Pub. No.: US 2017/0061926 A1
(43) Pub. Date: Mar. 2, 2017

(54) COLOR TRANSFORMATION USING NON-UNIFORMLY SAMPLED MULTI-DIMENSIONAL LOOKUP TABLE

(71) Applicant: INTEL CORPORATION, Santa Clara, CA (US)

(72) Inventor: Susanta Bhattacharjee, Bangalore (IN)

(73) Assignee: INTEL CORPORATION, Santa Clara, CA (US)

(21) Appl. No.: 14/843,735

(22) Filed: Sep. 2, 2015

(51) Int. Cl. G09G 5/06; G06T 1/20

(52) U.S. Cl. CPC G09G 5/06; G06T 1/20; G09G 2340/06; G06T 2200/28

(57) ABSTRACT

Embodiments provide for a graphics processing apparatus comprising a graphics processing unit including color conversion logic to convert from a first color to a second color using a non-uniformly sampled multi-dimensional lookup table. In one embodiment, the graphics processing logic additionally includes lookup table generation logic to generate the non-uniformly sampled multi-dimensional lookup table, where the lookup table logic includes a color transform unit to transform color data for a pixel from the first color to the second color, a sampling point unit to compute a set of non-uniform sampling points in the first color, and a lookup table sampler unit to generate the multi-dimensional lookup table for the second color using the non-uniform sampling points in the first color.

### TECHNICAL FIELD

Embodiments generally relate to graphics processing logic. More particularly, embodiments relate to graphics processing logic to perform color transformations.

### BACKGROUND

Color Transformation is of compute-generated images is performed for various reasons, including gamut mapping, color correction, and adaptive brightness or contrast enhancement. Of the various methods of implementing color transformation, a lookup table (LUT) based transformation is one of the fastest implementation methods. For non-linear color transformation, multidimensional LUTs may be used, where the lookup table has as many dimensions as the input color components of the chosen color. For example, a LUT for the sRGB color space, which is commonly used in the graphics and/or display domain, has three inputs, one each for Red, Green, and Blue. Accordingly, a LUT for sRGB is a 3D LUT. When both input and output are in sRGB space with depth of 8-bit per color, the LUT will consume 48 megabytes of memory. An LUT of such size not only consumes memory, but can negatively impact power and performance due to a significant increase in memory access when performing pixel processing using the LUT.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an embodiment of a computer system with a processor having one or more processor cores and graphics processors;

FIG. 2 is a block diagram of one embodiment of a processor having one or more processor cores, an integrated memory controller, and an integrated graphics processor;

FIG. 3 is a block diagram of one embodiment of a graphics processor which may be a discreet graphics processing unit, or may be graphics processor integrated with a plurality of processing cores;

FIG. 4 is a block diagram of an embodiment of a graphics processing engine for a graphics processor;

FIG. 5 is a block diagram of another embodiment of a graphics processor;

FIG. 6 is a block diagram of thread execution logic including an array of processing elements;

FIG. 7 illustrates a graphics processor execution unit instruction format according to an embodiment;

FIG. 8 is a block diagram of another embodiment of a graphics processor which includes a graphics pipeline, a media pipeline, a display engine, thread execution logic, and a render output pipeline;

FIG. 9A is a block diagram illustrating a graphics processor command format according to an embodiment;

FIG. 9B is a block diagram illustrating a graphics processor command sequence according to an embodiment;

FIG. 10 illustrates exemplary graphics software architecture for a data processing system according to an embodiment;

FIG. 11 is a block diagram illustrating an IP core development system that may be used to manufacture an integrated circuit to perform operations according to an embodiment;

FIG. 12 is a block diagram illustrating an exemplary system on a chip integrated circuit that may be fabricated using one or more IP cores, according to an embodiment;

FIG. 13 illustrates an exemplary 3D lookup table that may be used for color transformation;

FIG. 14 illustrates an exemplary sampled 3D lookup table that may be used for color transformation;

FIG. 15A-B illustrates uniform and non-uniform sampling with respect to a one-dimensional lookup table;

FIG. 16 illustrates exemplary transformations for a three-channel color;

FIG. 17 is a block diagram illustrating a system for determining sampling error of a sampled LUT that may be used to refine techniques for LUT generation;

FIG. 18 is a block diagram of a system to generate a multi-dimensional lookup table using non-uniform sample points, according to an embodiment;

FIG. 19 is a block diagram of a system for applying a non-uniformly sampled multi-dimensional LUT to pixel data, according to an embodiment;

FIG. 20 is a flow diagram of exemplary non-uniformly sampled LUT generation logic;

FIG. 21 is an illustration showing a representation of two-dimensional interpolation with an exemplary two-dimensional LUT;

FIG. 22 is a flow diagram of sample point determination logic, according to an embodiment;

FIG. 23 is a flow diagram of LUT operational logic, according to an embodiment; and

FIG. 24 is a block diagram of a computing device configured to perform color transformation using non-uniformly sampled multi-dimensional lookup table, according to an embodiment.

### DESCRIPTION OF EMBODIMENTS

To reduce the size of a LUT, a sampled LUT can be used. For example, a typical lookup table may have 17 equally distributed samples for each color components. Intermediate values between samples are interpolated while applying the LUT for color transformation. Using liner interpolation is simple hence common practice. Such sampling may introduce inaccuracies in the color transformation, but provides a more practical solution to multi-dimensional LUT based color transformation. Uniform sampling is the simplest form of sampling, but may be prone to severe inaccuracies, particularly in regions of the lookup table where data changes rapidly over the sampling points. Described herein, in various embodiments, is a system and method of performing color transformation using a non-uniformly sampled multi-dimensional lookup table.

For the purposes of explanation, numerous specific details are set forth to provide a thorough understanding of the various embodiments described below. However, it will be apparent to a skilled practitioner in the art that the embodiments may be practiced without some of these specific details. In other instances, well-known structures and devices are shown in block diagram form to avoid obscuring the underlying principles, and to provide a more thorough understanding of embodiments. Although some of the following embodiments are described with reference to a graphics processor, the techniques and teachings described herein may be applied to various types of circuits or semiconductor devices, including general purpose processing devices or graphic processing devices. Reference herein to “one embodiment” or “an embodiment” indicate that a particular feature, structure, or characteristic described in connection or association with the embodiment can be included in at least one of such embodiments. However, the appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

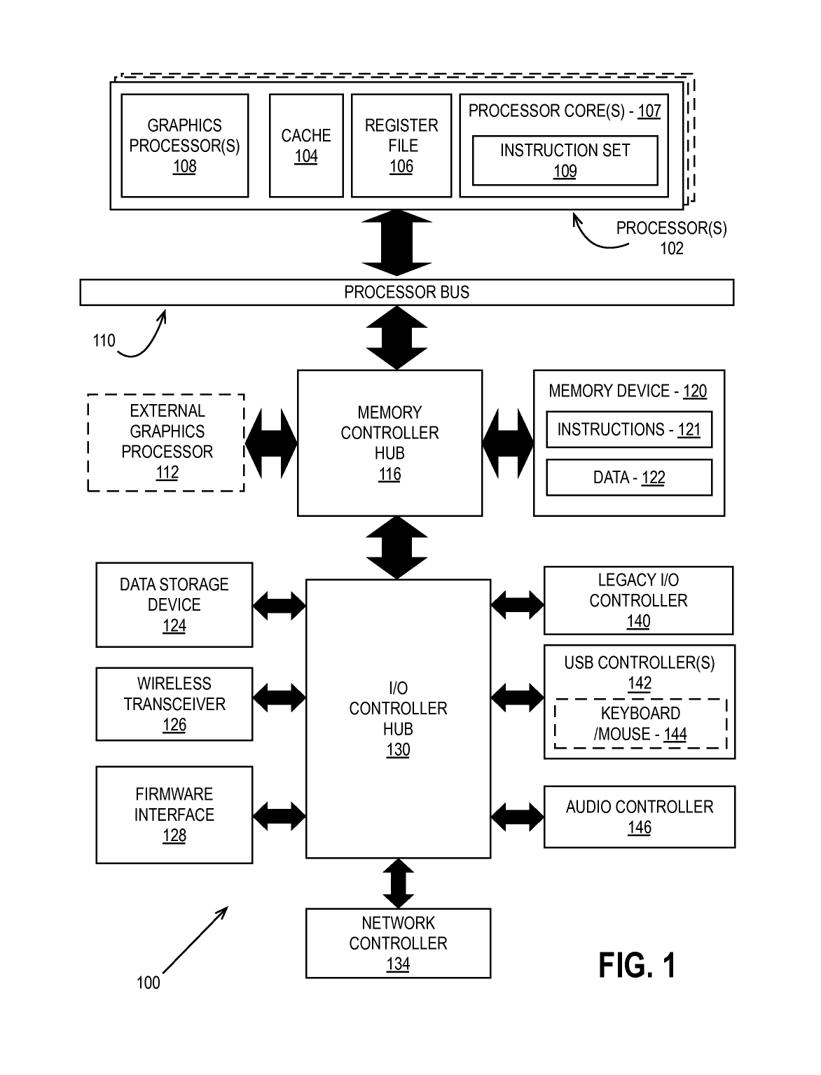

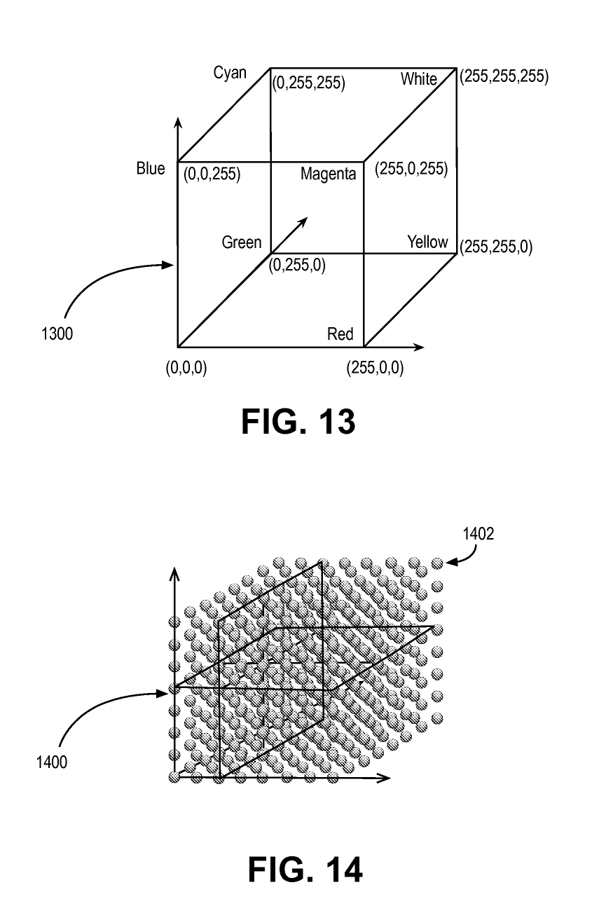

In the description that follows, FIGS. 1-12 provide an overview of exemplary data processing system and graphics processor logic that incorporates or relates to the various embodiments. FIGS. 13-24 provide specific details of the various embodiments.

### System Overview

FIG. 1 is a block diagram of a processing system 100, according to an embodiment. In various embodiments the system 100 includes one or more processors 102 and one or more graphics processors 108, and may be a single processor desktop system, a multiprocessor workstation system, or a server system having a large number of processors 102 or processor cores 107. In on embodiment, the system 100 is a processing platform incorporated within a system-on-a-chip (SoC) integrated circuit for use in mobile, handheld, or embedded devices.

An embodiment of system 100 can include, or be incorporated within a server-based gaming platform, a game console, including a game and media console, a mobile gaming console, a handheld game console, or an online game console. In some embodiments system 100 is a mobile phone, smart phone, tablet computing device or mobile Internet device. Data processing system 100 can also include, couple with, or be integrated within a wearable device, such as a smart watch wearable device, smart eyewear device, augmented reality device, or virtual reality device. In some embodiments, data processing system 100 is a television or set top box device having one or more processors 102 and a graphical interface generated by one or more graphics processors 108.

In some embodiments, the one or more processors 102 each include one or more processor cores 107 to process instructions which, when executed, perform operations for system and user software. In some embodiments, each of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). Multiple processor cores 107 may each process a different instruction set 109, which may include instructions to facilitate the emulation of other instruction sets. Processor core 107 may also include other processing devices, such a Digital Signal Processor (DSP).

In some embodiments, the processor 102 includes cache memory 104. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 is additionally included in processor 102 which may include different types of registers for storing different types of data (e.g., integer registers, floating point registers, status registers, and an instruction pointer register). Some registers may be general-purpose registers, while other registers may be specific to the design of the processor 102.

In some embodiments, processor 102 is coupled to a processor bus 110 to transmit communication signals such as address, data, or control signals between processor 102 and other components in system 100. In one embodiment the system 100 uses an exemplary ‘hub’ system architecture, including a memory controller hub 116 and an Input Output (I/O) controller hub 130. A memory controller hub 116 facilitates communication between a memory device and other components of system 100, while an I/O Controller Hub (ICH) 130 provides connections to I/O devices via a local I/O bus. In one embodiment, the logic of the memory controller hub 116 is integrated within the processor.

Memory device 120 can be a dynamic random access memory (DRAM) device, a static random access memory (SRAM) device, flash memory device, phase-change memory device, or some other memory device having suitable performance to serve as process memory. In one embodiment the memory device 120 can operate as system memory for the system 100, to store data 122 and instructions 121 for use when the one or more processors 102 executes an application or process. Memory controller hub 116 also couples with an optional external graphics processor 112, which may communicate with the one or more graphics processors 108 in processors 102 to perform graphics and media operations.

In some embodiments, ICH 130 enables peripherals to connect to memory device 120 and processor 102 via a high-speed I/O bus. The I/O peripherals include, but are not limited to, an audio controller 146, a firmware interface 128, a wireless transceiver 126 (e.g., Wi-Fi, Bluetooth), a data storage device 124 (e.g., hard disk drive, flash memory, etc.), and a legacy I/O controller 140 for coupling legacy (e.g., Personal System 2 (PS/2)) devices to the system. One or more Universal Serial Bus (USB) controllers 142 connect input devices, such as keyboard and mouse 144 combinations. A network controller 134 may also couple to ICH 130. In some embodiments, a high-performance network controller (not shown) couples to processor bus 110. It will be appreciated that the system 100 shown is exemplary and not limiting, as other types of data processing systems that are differently configured may also be used. For example, the I/O controller hub 130 may be integrated within the one or more processor 102, or the memory controller hub 116 and I/O controller hub 130 may be integrated into a discreet external graphics processor, such as the external graphics processor 112.

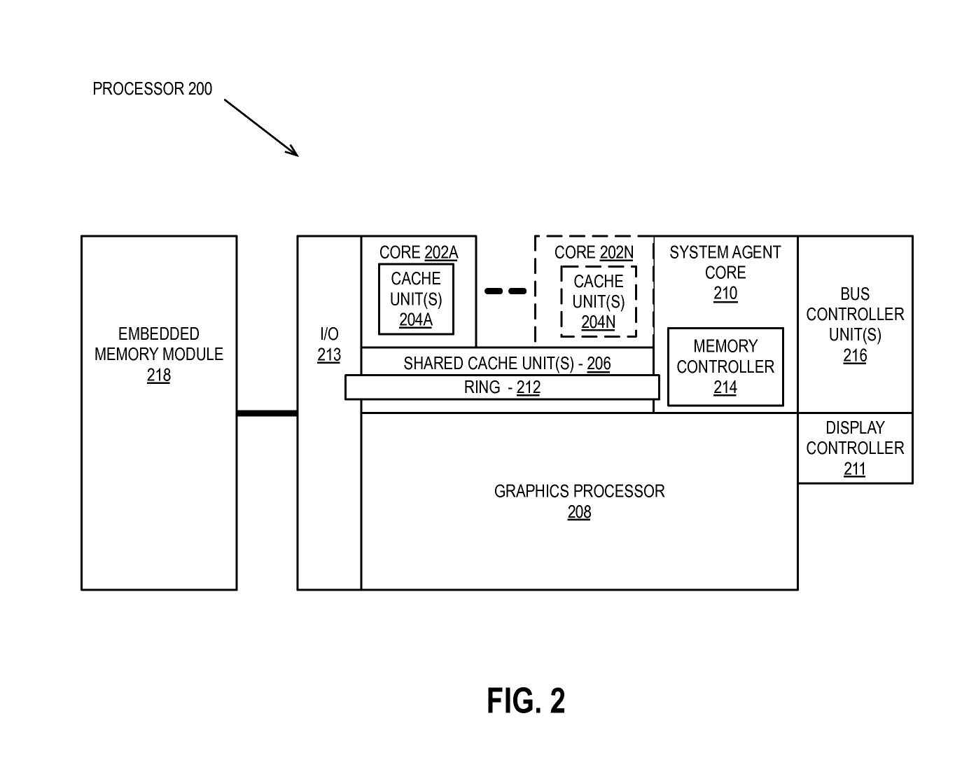

FIG. 2 is a block diagram of an embodiment of a processor 200 having one or more processor cores 202A-202N, an integrated memory controller 214, and an integrated graphics processor 208. Those elements of FIG. 2 having the same reference numbers (or names) as the elements of any other figure herein can operate or function in any manner similar to that described elsewhere herein, but are not limited to such. Processor 200 can include additional cores up to and including additional core 202N represented by the dashed lined boxes. Each of processor cores 202A-202N includes one or more internal cache units 204A-204N. In some embodiments each processor core also has access to one or more shared cached units 206.

The internal cache units 204A-204N and shared cache units 206 represent a cache memory hierarchy within the processor 200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 206 and 204A-204N.

In some embodiments, processor 200 may also include a set of one or more bus controller units 216 and a system agent core 210. The one or more bus controller units 216 manage a set of peripheral buses, such as one or more Peripheral Component Interconnect buses (e.g., PCI, PCI Express). System agent core 210 provides management functionality for the various processor components. In some embodiments, system agent core 210 includes one or more integrated memory controllers 214 to manage access to various external memory devices (not shown).

In some embodiments, one or more of the processor cores 202A-202N include support for simultaneous multi-threading. In such embodiment, the system agent core 210 includes components for coordinating and operating cores 202A-202N during multi-threaded processing. System agent core 210 may additionally include a power control unit (PCU), which includes logic and components to regulate the power state of processor cores 202A-202N and graphics processor 208.

In some embodiments, processor 200 additionally includes graphics processor 208 to execute graphics processing operations. In some embodiments, the graphics processor 208 couples with the set of shared cache units 206, and the system agent core 210, including the one or more integrated memory controllers 214. In some embodiments, a display controller 211 is coupled with the graphics processor 208 to drive graphics processor output to one or more coupled displays. In some embodiments, display controller 211 may be a separate module coupled with the graphics processor via at least one interconnect, or may be integrated within the graphics processor 208 or system agent core 210.

In some embodiments, a ring based interconnect unit 212 is used to couple the internal components of the processor 200. However, an alternative interconnect unit may be used, such as a point-to-point interconnect, a switched interconnect, or other techniques, including techniques well known in the art. In some embodiments, graphics processor 208 couples with the ring interconnect 212 via an I/O link 213.

The exemplary I/O link 213 represents at least one of multiple varieties of I/O interconnects, including an on package I/O interconnect which facilitates communication between various processor components and a high-performance embedded memory module 218, such as an eDRAM module. In some embodiments, each of the processor cores 202-202N and graphics processor 208 use embedded memory modules 218 as a shared Last Level Cache.

In some embodiments, processor cores 202A-202N are homogenous cores executing the same instruction set architecture. In another embodiment, processor cores 202A-202N are heterogeneous in terms of instruction set architecture (ISA), where one or more of processor cores 202A-N execute a first instruction set, while at least one of the other cores executes a subset of the first instruction set or a different instruction set. In one embodiment processor cores 202A-202N are heterogeneous in terms of microarchitecture, where one or more cores having a relatively higher power consumption couple with one or more power cores having a lower power consumption. Additionally, processor 200 can be implemented on one or more chips or as an SoC integrated circuit having the illustrated components, in addition to other components.

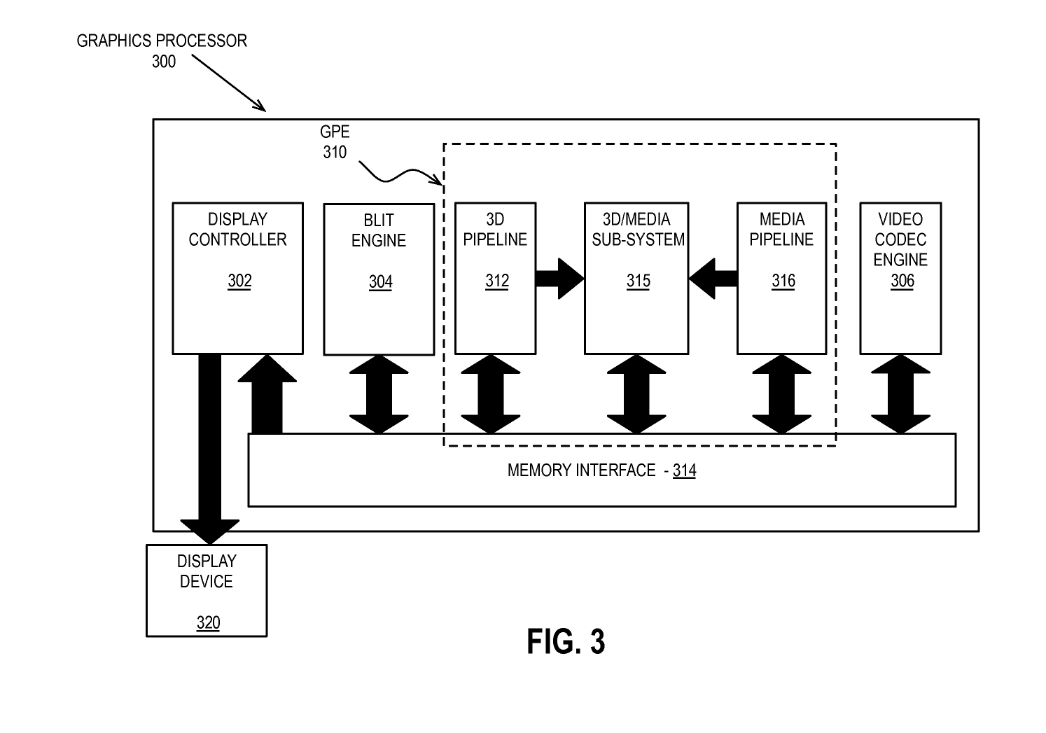

FIG. 3 is a block diagram of a graphics processor 300, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 300 includes a memory interface 314 to access memory. Memory interface 314 can be an interface to local memory, one or more internal caches, one or more shared external caches, and/or to system memory.

In some embodiments, graphics processor 300 also includes a display controller 302 to drive display output data to a display device 320. Display controller 302 includes hardware for one or more overlay planes for the display and composition of multiple layers of video or user interface elements. In some embodiments, graphics processor 300 includes a video codec engine 306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 300 includes a block image transfer (BLIT) engine 304 to perform two-dimensional (2D) rasterizer operations including, for example, bit-boundary block transfers. However, in one embodiment, 2D graphics operations are performed using one or more components of graphics processing engine (GPE) 310. In some embodiments, graphics processing engine 310 is a compute engine for performing graphics operations, including three-dimensional (3D) graphics operations and media operations.

In some embodiments, GPE 310 includes a 3D pipeline 312 for performing 3D operations, such as rendering three-dimensional images and scenes using processing functions that act upon 3D primitive shapes (e.g., rectangle, triangle, etc.). The 3D pipeline 312 includes programmable and fixed function elements that perform various tasks within the element and/or spawn execution threads to a 3D/Media sub-system 315. While 3D pipeline 312 can be used to perform media operations, an embodiment of GPE 310 also includes a media pipeline 316 that is specifically used to perform media operations, such as video post-processing and image enhancement.

In some embodiments, media pipeline 316 includes fixed function or programmable logic units to perform one or more specialized media operations, such as video decode acceleration, video de-interlacing, and video encode acceleration in place of, or on behalf of video codec engine 306. In some embodiments, media pipeline 316 additionally includes a thread spawning unit to spawn threads for execution on 3D/Media sub-system 315. The spawned threads perform computations for the media operations on one or more graphics execution units included in 3D/Media sub-system 315.

In some embodiments, 3D/Media subsystem 315 includes logic for executing threads spawned by 3D pipeline 312 and media pipeline 316. In one embodiment, the pipelines send thread execution requests to 3D/Media subsystem 315, which includes thread dispatch logic for arbitrating and dispatching the various requests to available thread execution resources. The execution resources include an array of graphics execution units to process the 3D and media threads. In some embodiments, 3D/Media subsystem 315 includes one or more internal caches for thread instructions and data. In some embodiments, the subsystem also includes shared memory, including registers and addressable memory, to share data between threads and to store output data.

### 3D/Media Processing

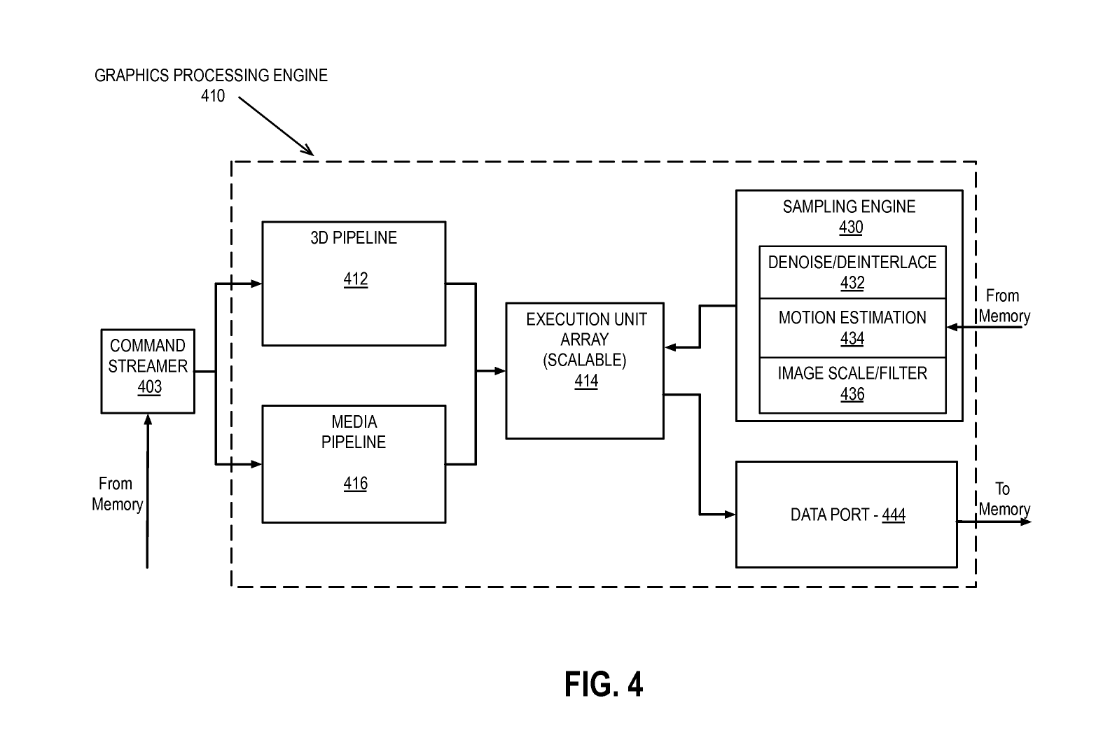

FIG. 4 is a block diagram of a graphics processing engine 410 of a graphics processor in accordance with some embodiments. In one embodiment, the GPE 410 is a version of the GPE 310 shown in FIG. 3. Elements of FIG. 4 having the same reference numbers (or names) as the elements of any other figure herein can operate or function in any manner similar to that described elsewhere herein, but are not limited to such.

In some embodiments, GPE 410 couples with a command streamer 403, which provides a command stream to the GPE 3D and media pipelines 412, 416. In some embodiments, command streamer 403 is coupled to memory, which can be system memory, or one or more of internal cache memory and shared cache memory. In some embodiments, command streamer 403 receives commands from the memory and sends the commands to 3D pipeline 412 and/or media pipeline 416. The commands are directives fetched from a ring buffer, which stores commands for the 3D and media pipelines 412, 416. In one embodiment, the ring buffer can additionally include batch command buffers storing batches of multiple commands. The 3D and media pipelines 412, 416 process the commands by performing operations via logic within the respective pipelines or by dispatching one or more execution threads to an execution unit array 414. In some embodiments, execution unit array 414 is scalable, such that the array includes a variable number of execution units based on the target power and performance level of GPE 410.

In some embodiments, a sampling engine 430 couples with memory (e.g., cache memory or system memory) and execution unit array 414. In some embodiments, sampling engine 430 provides a memory access mechanism for execution unit array 414 that allows execution array 414 to read graphics and media data from memory. In some embodiments, sampling engine 430 includes logic to perform specialized image sampling operations for media.

In some embodiments, the specialized media sampling logic in sampling engine 430 includes a de-noise/de-interlace module 432, a motion estimation module 434, and an image scaling and filtering module 436. In some embodiments, de-noise/de-interlace module 432 includes logic to perform one or more of a de-noise or a de-interlace algorithm on decoded video data. The de-interlace logic combines alternating fields of interlaced video content into a single fame of video. The de-noise logic reduces or removes data noise from video and image data. In some embodiments, the de-noise logic and de-interlace logic are motion adaptive and use spatial or temporal filtering based on the amount of motion detected in the video data. In some embodiments, the de-noise/de-interlace module 432 includes dedicated motion detection logic (e.g., within the motion estimation engine 434).

In some embodiments, motion estimation engine 434 provides hardware acceleration for video operations by performing video acceleration functions such as motion vector estimation and prediction on video data. The motion estimation engine determines motion vectors that describe the transformation of image data between successive video frames. In some embodiments, a graphics processor media codec uses video motion estimation engine 434 to perform operations on video at the macro-block level that may otherwise be too computationally intensive to perform with a general-purpose processor. In some embodiments, motion estimation engine 434 is generally available to graphics processor components to assist with video decode and processing functions that are sensitive or adaptive to the direction or magnitude of the motion within video data.

In some embodiments, image scaling and filtering module 436 performs image-processing operations to enhance the visual quality of generated images and video. In some embodiments, scaling and filtering module 436 processes image and video data during the sampling operation before providing the data to execution unit array 414.

In some embodiments, the GPE 410 includes a data port 444, which provides an additional mechanism for graphics subsystems to access memory. In some embodiments, data port 444 facilitates memory access for operations including render target writes, constant buffer reads, scratch memory space reads/writes, and media surface accesses. In some embodiments, data port 444 includes cache memory space to cache accesses to memory. The cache memory can be a single data cache or separated into multiple caches for the multiple subsystems that access memory via the data port (e.g., a render buffer cache, a constant buffer cache, etc.). In some embodiments, threads executing on an execution unit in execution unit array 414 communicate with the data port by exchanging messages via a data distribution interconnect that couples each of the sub-systems of GPE 410.

### Execution Units

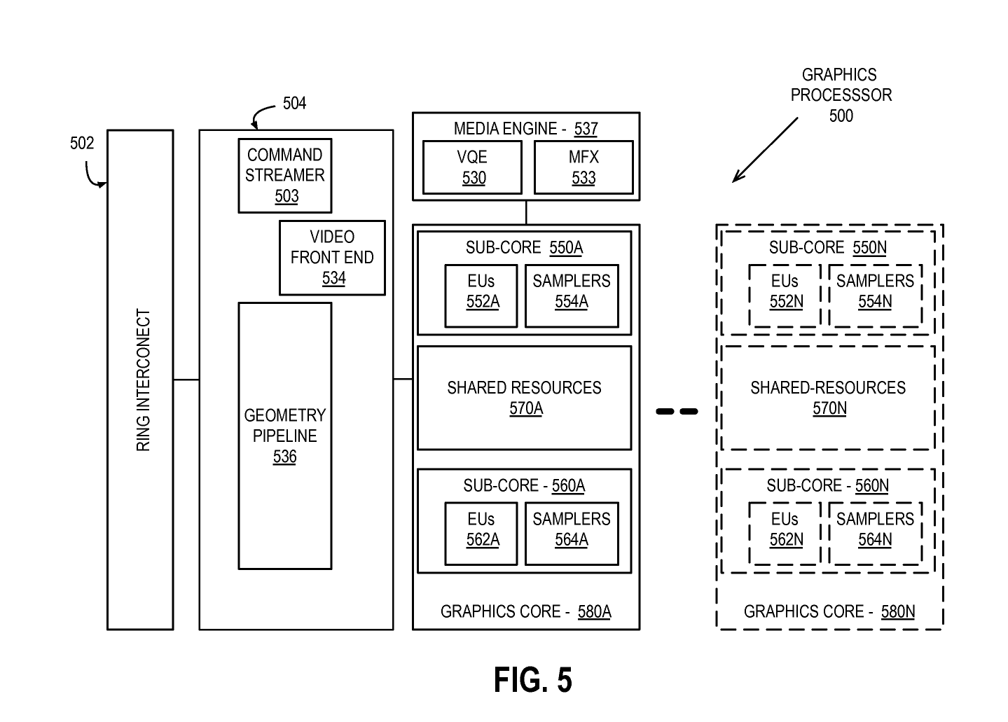

FIG. 5 is a block diagram of another embodiment of a graphics processor 500. Elements of FIG. 5 having the same reference numbers (or names) as the elements of any other figure herein can operate or function in any manner similar to that described elsewhere herein, but are not limited to such.

In some embodiments, graphics processor 500 includes a ring interconnect 502, a pipeline front-end 504, a media engine 537, and graphics cores 580A-580N. In some embodiments, ring interconnect 502 couples the graphics processor to other processing units, including other graphics processors or one or more general-purpose processor cores. In some embodiments, the graphics processor is one of many processors integrated within a multi-core processing system.

In some embodiments, graphics processor 500 receives batches of commands via ring interconnect 502. The incoming commands are interpreted by a command streamer 503 in the pipeline front-end 504. In some embodiments, graphics processor 500 includes scalable execution logic to perform 3D geometry processing and media processing via the graphics core(s) 580A-580N. For 3D geometry processing commands, command streamer 503 supplies commands to geometry pipeline 536. For at least some media processing commands, command streamer 503 supplies the commands to a video front end 534, which couples with a media engine 537. In some embodiments, media engine 537 includes a Video Quality Engine (VQE) 530 for video and image post-processing and a multi-format encode/decode (MFX) 533 engine to provide hardware-accelerated media data encode and decode. In some embodiments, geometry pipeline 536 and media engine 537 each generate execution threads for the thread execution resources provided by at least one graphics core 580A.

In some embodiments, graphics processor 500 includes scalable thread execution resources featuring modular cores 580A-580N (sometimes referred to as core slices), each having multiple sub-cores 550A-550N, 560A-560N (sometimes referred to as core sub-slices). In some embodiments, graphics processor 500 can have any number of graphics cores 580A through 580N. In some embodiments, graphics processor 500 includes a graphics core 580A having at least a first sub-core 550A and a second core sub-core 560A. In other embodiments, the graphics processor is a low power processor with a single sub-core (e.g., 550A). In some embodiments, graphics processor 500 includes multiple graphics cores 580A-580N, each including a set of first sub-cores 550A-550N and a set of second sub-cores 560A-560N. Each sub-core in the set of first sub-cores 550A-550N includes at least a first set of execution units 552A-552N and media/texture samplers 554A-554N. Each sub-core in the set of second sub-cores 560A-560N includes at least a second set of execution units 562A-562N and samplers 564A-564N. In some embodiments, each sub-core 550A-550N, 560A-560N shares a set of shared resources 570A-570N. In some embodiments, the shared resources include shared cache memory and pixel operation logic. Other shared resources may also be included in the various embodiments of the graphics processor.

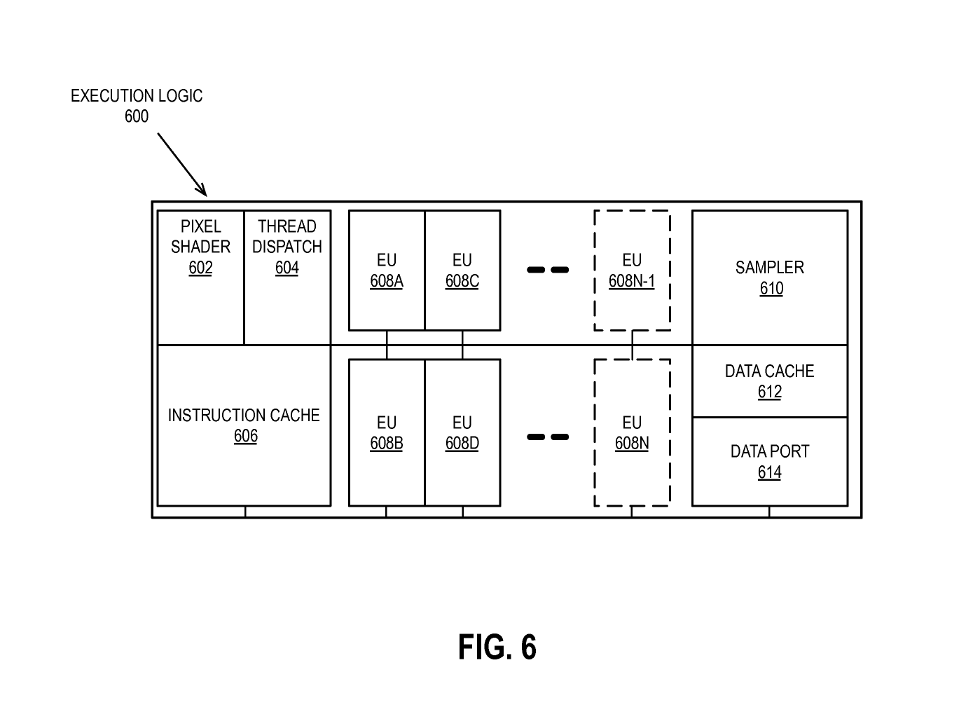

FIG. 6 illustrates thread execution logic 600 including an array of processing elements employed in some embodiments of a GPE. Elements of FIG. 6 having the same reference numbers (or names) as the elements of any other figure herein can operate or function in any manner similar to that described elsewhere herein, but are not limited to such.

In some embodiments, thread execution logic 600 includes a pixel shader 602, a thread dispatcher 604, instruction cache 606, a scalable execution unit array including a plurality of execution units 608A-608N, a sampler 610, a data cache 612, and a data port 614. In one embodiment the included components are interconnected via an interconnect fabric that links to each of the components. In some embodiments, thread execution logic 600 includes one or more connections to memory, such as system memory or cache memory, through one or more of instruction cache 606, data port 614, sampler 610, and execution unit array 608A-608N. In some embodiments, each execution unit (e.g. 608A) is an individual vector processor capable of executing multiple simultaneous threads and processing multiple data elements in parallel for each thread. In some embodiments, execution unit array 608A-608N includes any number individual execution units.

In some embodiments, execution unit array 608A-608N is primarily used to execute “shader” programs. In some embodiments, the execution units in array 608A-608N execute an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders).

Each execution unit in execution unit array 608A-608N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some embodiments, execution units 608A-608N support integer and floating-point data types.

The execution unit instruction set includes single instruction multiple data (SIMD) instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

One or more internal instruction caches (e.g., 606) are included in the thread execution logic 600 to cache thread instructions for the execution units. In some embodiments, one or more data caches (e.g., 612) are included to cache thread data during thread execution. In some embodiments, sampler 610 is included to provide texture sampling for 3D operations and media sampling for media operations. In some embodiments, sampler 610 includes specialized texture or media sampling functionality to process texture or media data during the sampling process before providing the sampled data to an execution unit.

During execution, the graphics and media pipelines send thread initiation requests to thread execution logic 600 via thread spawning and dispatch logic. In some embodiments, thread execution logic 600 includes a local thread dispatcher 604 that arbitrates thread initiation requests from the graphics and media pipelines and instantiates the requested threads on one or more execution units 608A-608N. For example, the geometry pipeline (e.g., 536 of FIG. 5) dispatches vertex processing, tessellation, or geometry processing threads to thread execution logic 600 (FIG. 6). In some embodiments, thread dispatcher 604 can also process runtime thread spawning requests from the executing shader programs.

Once a group of geometric objects has been processed and rasterized into pixel data, pixel shader 602 is invoked to further compute output information and cause results to be written to output surfaces (e.g., color buffers, depth buffers, stencil buffers, etc.). In some embodiments, pixel shader 602 calculates the values of the various vertex attributes that are to be interpolated across the rasterized object. In some embodiments, pixel shader 602 then executes an application programming interface (API)-supplied pixel shader program. To execute the pixel shader program, pixel shader 602 dispatches threads to an execution unit (e.g., 608A) via thread dispatcher 604. In some embodiments, pixel shader 602 uses texture sampling logic in sampler 610 to access texture data in texture maps stored in memory. Arithmetic operations on the texture data and the input geometry data compute pixel color data for each geometric fragment, or discards one or more pixels from further processing.

In some embodiments, the data port 614 provides a memory access mechanism for the thread execution logic 600 output processed data to memory for processing on a graphics processor output pipeline. In some embodiments, the data port 614 includes or couples to one or more cache memories (e.g., data cache 612) to cache data for memory access via the data port.

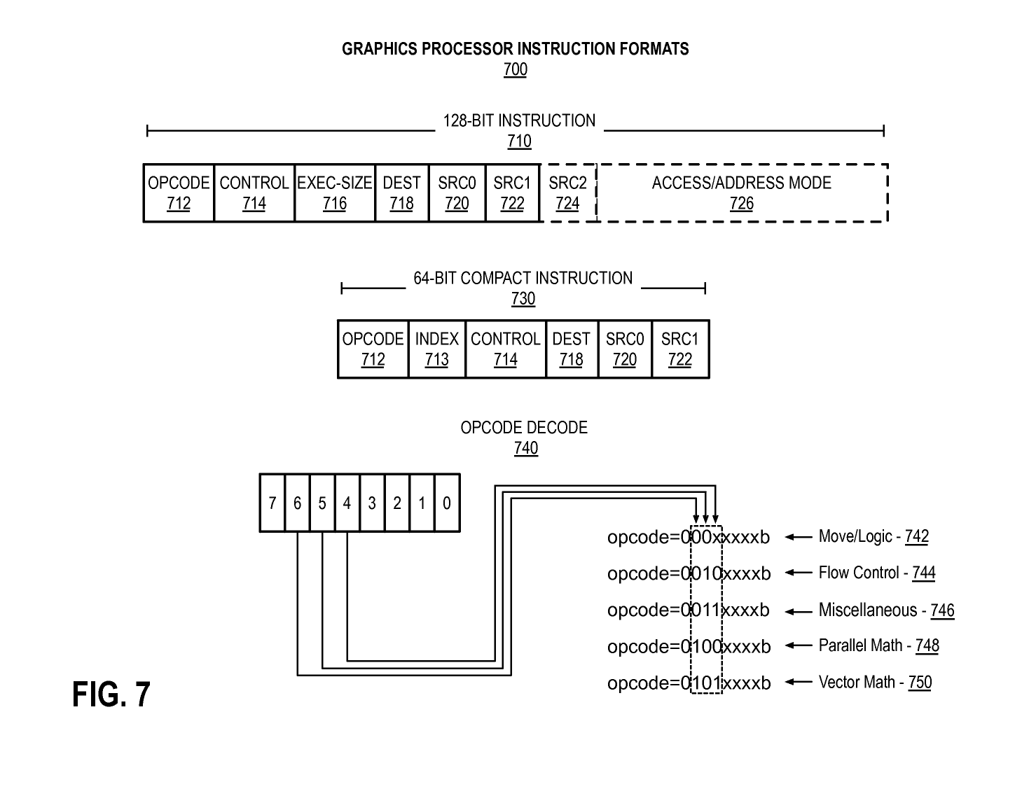

FIG. 7 is a block diagram illustrating a graphics processor instruction formats 700 according to some embodiments. In one or more embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. In some embodiments, instruction format 700 described and illustrated are macro-instructions, in that they are instructions supplied to the execution unit, as opposed to micro-operations resulting from instruction decode once the instruction is processed.

In some embodiments, the graphics processor execution units natively support instructions in a 128-bit format 710. A 64-bit compacted instruction format 730 is available for some instructions based on the selected instruction, instruction options, and number of operands. The native 128-bit format 710 provides access to all instruction options, while some options and operations are restricted in the 64-bit format 730. The native instructions available in the 64-bit format 730 vary by embodiment. In some embodiments, the instruction is compacted in part using a set of index values in an index field 713. The execution unit hardware references a set of compaction tables based on the index values and uses the compaction table outputs to reconstruct a native instruction in the 128-bit format 710.

For each format, instruction opcode 712 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some embodiments, instruction control field 714 enables control over certain execution options, such as channels selection (e.g., predication) and data channel order (e.g., swizzle). For 128-bit instructions 710 an exec-size field 716 limits the number of data channels that will be executed in parallel. In some embodiments, exec-size field 716 is not available for use in the 64-bit compact instruction format 730.

Some execution unit instructions have up to three operands including two source operands, src0 720, src1 722, and one destination 718. In some embodiments, the execution units support dual destination instructions, where one of the destinations is implied. Data manipulation instructions can have a third source operand (e.g., SRC2 724), where the instruction opcode 712 determines the number of source operands. An instruction's last source operand can be an immediate (e.g., hard-coded) value passed with the instruction.

In some embodiments, the 128-bit instruction format 710 includes an access/address mode information 726 specifying, for example, whether direct register addressing mode or indirect register addressing mode is used. When direct register addressing mode is used, the register address of one or more operands is directly provided by bits in the instruction 710.

In some embodiments, the 128-bit instruction format 710 includes an access/address mode field 726, which specifies an address mode and/or an access mode for the instruction. In one embodiment the access mode to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction 710 may use byte-aligned addressing for source and destination operands and when in a second mode, the instruction 710 may use 16-byte-aligned addressing for all source and destination operands.

In one embodiment, the address mode portion of the access/address mode field 726 determines whether the instruction is to use direct or indirect addressing. When direct register addressing mode is used bits in the instruction 710 directly provide the register address of one or more operands. When indirect register addressing mode is used, the register address of one or more operands may be computed based on an address register value and an address immediate field in the instruction.

In some embodiments instructions are grouped based on opcode 712 bit-fields to simplify Opcode decode 740. For an 8-bit opcode, bits 4, 5, and 6 allow the execution unit to determine the type of opcode. The precise opcode grouping shown is merely an example. In some embodiments, a move and logic opcode group 742 includes data movement and logic instructions (e.g., move (mov), compare (cmp)). In some embodiments, move and logic group 742 shares the five most significant bits (MSB), where move (mov) instructions are in the form of 0000xxxxb and logic instructions are in the form of 0001xxxxb. A flow control instruction group 744 (e.g., call, jump (jmp)) includes instructions in the form of 0010xxxxb (e.g., 0x20). A miscellaneous instruction group 746 includes a mix of instructions, including synchronization instructions (e.g., wait, send) in the form of 0011xxxxb (e.g., 0x30). A parallel math instruction group 748 includes component-wise arithmetic instructions (e.g., add, multiply (mul)) in the form of 0100xxxxb (e.g., 0x40). The parallel math group 748 performs the arithmetic operations in parallel across data channels. The vector math group 750 includes arithmetic instructions (e.g., dp4) in the form of 0101xxxxb (e.g., 0x50). The vector math group performs arithmetic such as dot product calculations on vector operands.

### Graphics Pipeline

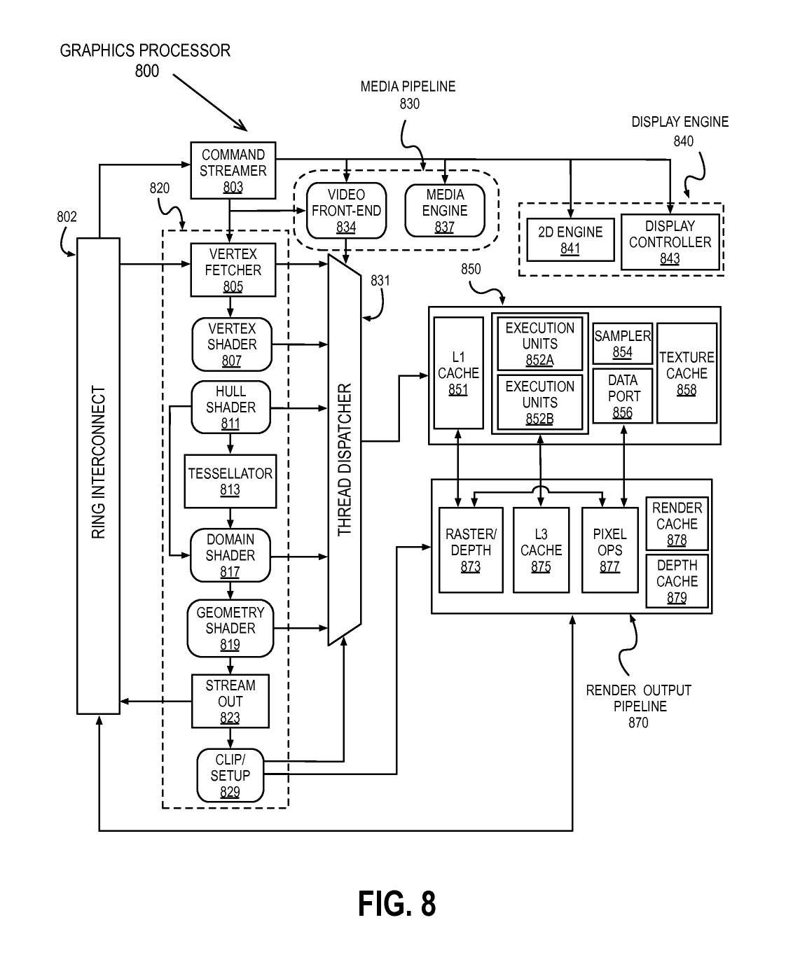

FIG. 8 is a block diagram of another embodiment of a graphics processor 800. Elements of FIG. 8 having the same reference numbers (or names) as the elements of any other figure herein can operate or function in any manner similar to that described elsewhere herein, but are not limited to such.

In some embodiments, graphics processor 800 includes a graphics pipeline 820, a media pipeline 830, a display engine 840, thread execution logic 850, and a render output pipeline 870. In some embodiments, graphics processor 800 is a graphics processor within a multi-core processing system that includes one or more general-purpose processing cores. The graphics processor is controlled by register writes to one or more control registers (not shown) or via commands issued to graphics processor 800 via a ring interconnect 802. In some embodiments, ring interconnect 802 couples graphics processor 800 to other processing components, such as other graphics processors or general-purpose processors. Commands from ring interconnect 802 are interpreted by a command streamer 803, which supplies instructions to individual components of graphics pipeline 820 or media pipeline 830.

In some embodiments, command streamer 803 directs the operation of a vertex fetcher 805 that reads vertex data from memory and executes vertex-processing commands provided by command streamer 803. In some embodiments, vertex fetcher 805 provides vertex data to a vertex shader 807, which performs coordinate space transformation and lighting operations to each vertex. In some embodiments, vertex fetcher 805 and vertex shader 807 execute vertex-processing instructions by dispatching execution threads to execution units 852A, 852B via a thread dispatcher 831.

In some embodiments, execution units 852A, 852B are an array of vector processors having an instruction set for performing graphics and media operations. In some embodiments, execution units 852A, 852B have an attached L1 cache 851 that is specific for each array or shared between the arrays. The cache can be configured as a data cache, an instruction cache, or a single cache that is partitioned to contain data and instructions in different partitions.

In some embodiments, graphics pipeline 820 includes tessellation components to perform hardware-accelerated tessellation of 3D objects. In some embodiments, a programmable hull shader 811 configures the tessellation operations. A programmable domain shader 817 provides back-end evaluation of tessellation output. A tessellator 813 operates at the direction of hull shader 811 and contains special purpose logic to generate a set of detailed geometric objects based on a coarse geometric model that is provided as input to graphics pipeline 820. In some embodiments, if tessellation is not used, tessellation components 811, 813, 817 can be bypassed.

In some embodiments, complete geometric objects can be processed by a geometry shader 819 via one or more threads dispatched to execution units 852A, 852B, or can proceed directly to the clipper 829. In some embodiments, the geometry shader operates on entire geometric objects, rather than vertices or patches of vertices as in previous stages of the graphics pipeline. If the tessellation is disabled the geometry shader 819 receives input from the vertex shader 807. In some embodiments, geometry shader 819 is programmable by a geometry shader program to perform geometry tessellation if the tessellation units are disabled.

Before rasterization, a clipper 829 processes vertex data. The clipper 829 may be a fixed function clipper or a programmable clipper having clipping and geometry shader functions. In some embodiments, a rasterizer and depth test component 873 in the render output pipeline 870 dispatches pixel shaders to convert the geometric objects into their per pixel representations. In some embodiments, pixel shader logic is included in thread execution logic 850. In some embodiments, an application can bypass the rasterizer 873 and access un-rasterized vertex data via a stream out unit 823.

The graphics processor 800 has an interconnect bus, interconnect fabric, or some other interconnect mechanism that allows data and message passing amongst the major components of the processor. In some embodiments, execution units 852A, 852B and associated cache(s) 851, texture and media sampler 854, and texture/sampler cache 858 interconnect via a data port 856 to perform memory access and communicate with render output pipeline components of the processor. In some embodiments, sampler 854, caches 851, 858 and execution units 852A, 852B each have separate memory access paths.

In some embodiments, render output pipeline 870 contains a rasterizer and depth test component 873 that converts vertex-based objects into an associated pixel-based representation. In some embodiments, the render output pipeline 870 includes a windower/masker unit to perform fixed function triangle and line rasterization. An associated render cache 878 and depth cache 879 are also available in some embodiments. A pixel operations component 877 performs pixel-based operations on the data, though in some instances, pixel operations associated with 2D operations (e.g. bit block image transfers with blending) are performed by the 2D engine 841, or substituted at display time by the display controller 843 using overlay display planes. In some embodiments, a shared L3 cache 875 is available to all graphics components, allowing the sharing of data without the use of main system memory.

In some embodiments, graphics processor media pipeline 830 includes a media engine 837 and a video front end 834. In some embodiments, video front end 834 receives pipeline commands from the command streamer 803. In some embodiments, media pipeline 830 includes a separate command streamer. In some embodiments, video front-end 834 processes media commands before sending the command to the media engine 837. In some embodiments, media engine 837 includes thread spawning functionality to spawn threads for dispatch to thread execution logic 850 via thread dispatcher 831.

In some embodiments, graphics processor 800 includes a display engine 840. In some embodiments, display engine 840 is external to processor 800 and couples with the graphics processor via the ring interconnect 802, or some other interconnect bus or fabric. In some embodiments, display engine 840 includes a 2D engine 841 and a display controller 843. In some embodiments, display engine 840 contains special purpose logic capable of operating independently of the 3D pipeline. In some embodiments, display controller 843 couples with a display device (not shown), which may be a system integrated display device, as in a laptop computer, or an external display device attached via a display device connector.

In some embodiments, graphics pipeline 820 and media pipeline 830 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL) and Open Computing Language (OpenCL) from the Khronos Group, the Direct3D library from the Microsoft Corporation, or support may be provided to both OpenGL and D3D. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

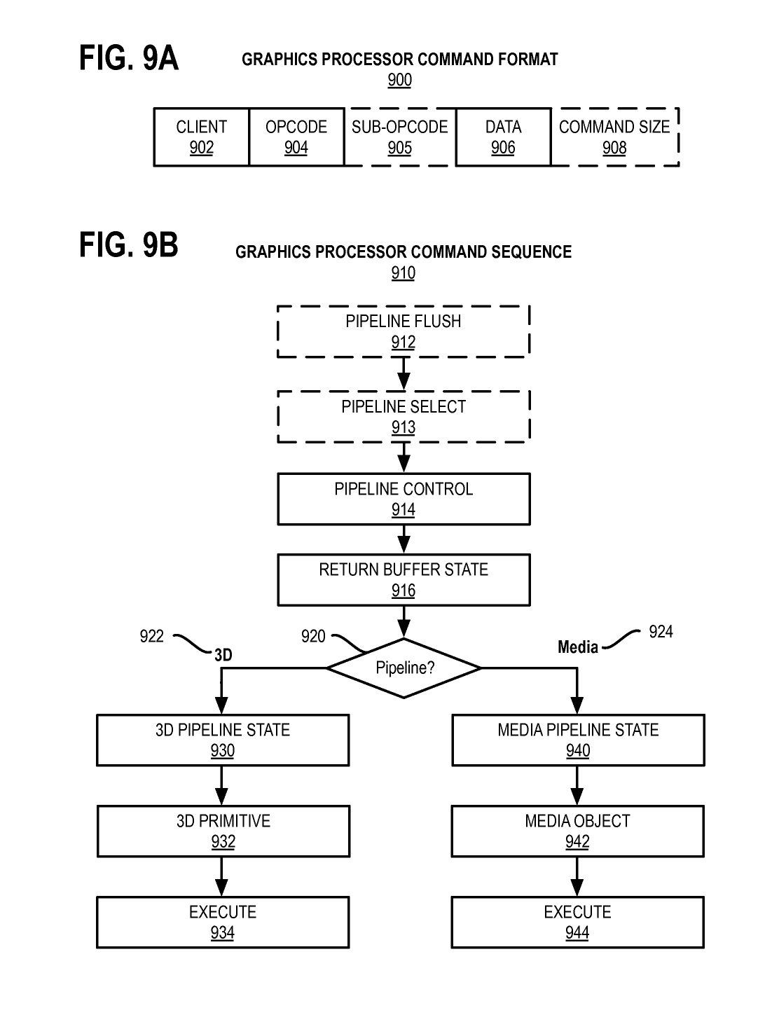

FIG. 9A is a block diagram illustrating a graphics processor command format 900 according to some embodiments. FIG. 9B is a block diagram illustrating a graphics processor command sequence 910 according to an embodiment. The solid lined boxes in FIG. 9A illustrate the components that are generally included in a graphics command while the dashed lines include components that are optional or that are only included in a sub-set of the graphics commands. The exemplary graphics processor command format 900 of FIG. 9A includes data fields to identify a target client 902 of the command, a command operation code (opcode) 904, and the relevant data 906 for the command. A sub-opcode 905 and a command size 908 are also included in some commands.

In some embodiments, client 902 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 904 and, if present, sub-opcode 905 to determine the operation to perform. The client unit performs the command using information in data field 906. For some commands an explicit command size 908 is expected to specify the size of the command. In some embodiments, the command parser automatically determines the size of at least some of the commands based on the command opcode. In some embodiments commands are aligned via multiples of a double word.

The flow diagram in FIG. 9B shows an exemplary graphics processor command sequence 910. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 910 may begin with a pipeline flush command 912 to cause any active graphics pipeline to complete the currently pending commands for the pipeline. In some embodiments, the 3D pipeline 922 and the media pipeline 924 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 912 can be used for pipeline synchronization or before placing the graphics processor into a low power state.

In some embodiments, a pipeline select command 913 is used when a command sequence requires the graphics processor to explicitly switch between pipelines. In some embodiments, a pipeline select command 913 is required only once within an execution context before issuing pipeline commands unless the context is to issue commands for both pipelines. In some embodiments, a pipeline flush command is 912 is required immediately before a pipeline switch via the pipeline select command 913.

In some embodiments, a pipeline control command 914 configures a graphics pipeline for operation and is used to program the 3D pipeline 922 and the media pipeline 924. In some embodiments, pipeline control command 914 configures the pipeline state for the active pipeline. In one embodiment, the pipeline control command 914 is used for pipeline synchronization and to clear data from one or more cache memories within the active pipeline before processing a batch of commands.

In some embodiments, return buffer state commands 916 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 916 includes selecting the size and number of return buffers to use for a set of pipeline operations.

The remaining commands in the command sequence differ based on the active pipeline for operations. Based on a pipeline determination 920, the command sequence is tailored to the 3D pipeline 922 beginning with the 3D pipeline state 930, or the media pipeline 924 beginning at the media pipeline state 940.

The commands for the 3D pipeline state 930 include 3D state setting commands for vertex buffer state, vertex element state, constant color state, depth buffer state, and other state variables that are to be configured before 3D primitive commands are processed. The values of these commands are determined at least in part based the particular 3D API in use. In some embodiments, 3D pipeline state 930 commands are also able to selectively disable or bypass certain pipeline elements if those elements will not be used.

In some embodiments, 3D primitive 932 command is used to submit 3D primitives to be processed by the 3D pipeline. Commands and associated parameters that are passed to the graphics processor via the 3D primitive 932 command are forwarded to the vertex fetch function in the graphics pipeline. The vertex fetch function uses the 3D primitive 932 command data to generate vertex data structures. The vertex data structures are stored in one or more return buffers. In some embodiments, 3D primitive 932 command is used to perform vertex operations on 3D primitives via vertex shaders. To process vertex shaders, 3D pipeline 922 dispatches shader execution threads to graphics processor execution units.

In some embodiments, 3D pipeline 922 is triggered via an execute 934 command or event. In some embodiments, a register write triggers command execution. In some embodiments execution is triggered via a ‘go’ or ‘kick’ command in the command sequence. In one embodiment command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some embodiments, the graphics processor command sequence 910 follows the media pipeline 924 path when performing media operations. In general, the specific use and manner of programming for the media pipeline 924 depends on the media or compute operations to be performed. Specific media decode operations may be offloaded to the media pipeline during media decode. In some embodiments, the media pipeline can also be bypassed and media decode can be performed in whole or in part using resources provided by one or more general-purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 924 is configured in a similar manner as the 3D pipeline 922. A set of media pipeline state commands 940 are dispatched or placed into in a command queue before the media object commands 942. In some embodiments, media pipeline state commands 940 include data to configure the media pipeline elements that will be used to process the media objects. This includes data to configure the video decode and video encode logic within the media pipeline, such as encode or decode format. In some embodiments, media pipeline state commands 940 also support the use one or more pointers to “indirect” state elements that contain a batch of state settings.

In some embodiments, media object commands 942 supply pointers to media objects for processing by the media pipeline. The media objects include memory buffers containing video data to be processed. In some embodiments, all media pipeline states must be valid before issuing a media object command 942. Once the pipeline state is configured and media object commands 942 are queued, the media pipeline 924 is triggered via an execute command 944 or an equivalent execute event (e.g., register write). Output from media pipeline 924 may then be post processed by operations provided by the 3D pipeline 922 or the media pipeline 924. In some embodiments, GPGPU operations are configured and executed in a similar manner as media operations.

### Graphics Software Architecture

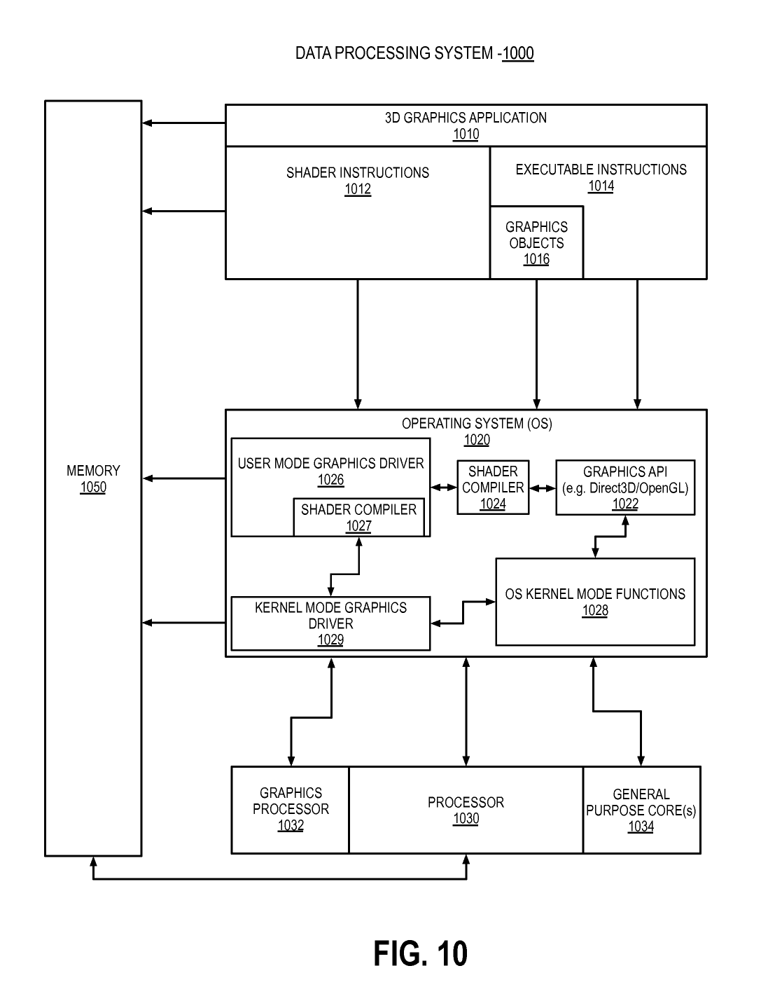

FIG. 10 illustrates exemplary graphics software architecture for a data processing system 1000 according to some embodiments. In some embodiments, software architecture includes a 3D graphics application 1010, an operating system 1020, and at least one processor 1030. In some embodiments, processor 1030 includes a graphics processor 1032 and one or more general-purpose processor core(s) 1034. The graphics application 1010 and operating system 1020 each execute in the system memory 1050 of the data processing system.

In some embodiments, 3D graphics application 1010 contains one or more shader programs including shader instructions 1012. The shader language instructions may be in a high-level shader language, such as the High Level Shader Language (HLSL) or the OpenGL Shader Language (GLSL). The application also includes executable instructions 1014 in a machine language suitable for execution by the general-purpose processor core 1034. The application also includes graphics objects 1016 defined by vertex data.

In some embodiments, operating system 1020 is a Microsoft® Windows® operating system from the Microsoft Corporation, a proprietary UNIX-like operating system, or an open source UNIX-like operating system using a variant of the Linux kernel. When the Direct3D API is in use, the operating system 1020 uses a front-end shader compiler 1024 to compile any shader instructions 1012 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 1010.

In some embodiments, user mode graphics driver 1026 contains a back-end shader compiler 1027 to convert the shader instructions 1012 into a hardware specific representation. When the OpenGL API is in use, shader instructions 1012 in the GLSL high-level language are passed to a user mode graphics driver 1026 for compilation. In some embodiments, user mode graphics driver 1026 uses operating system kernel mode functions 1028 to communicate with a kernel mode graphics driver 1029. In some embodiments, kernel mode graphics driver 1029 communicates with graphics processor 1032 to dispatch commands and instructions.

### IP Core Implementations

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

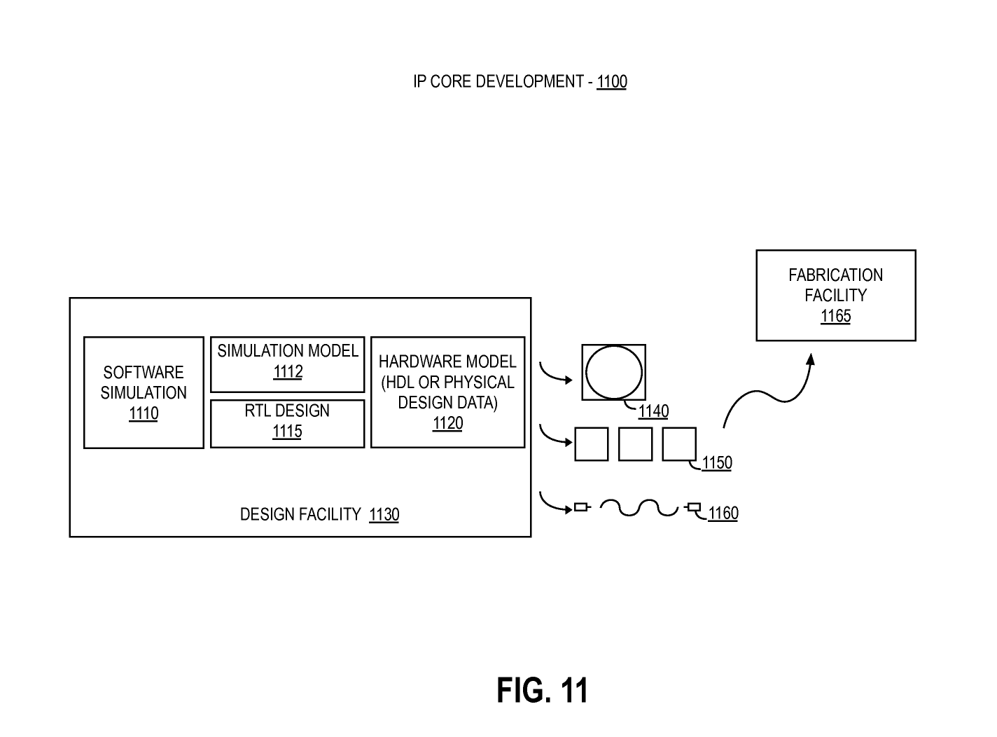

FIG. 11 is a block diagram illustrating an IP core development system 1100 that may be used to manufacture an integrated circuit to perform operations according to an embodiment. The IP core development system 1100 may be used to generate modular, re-usable designs that can be incorporated into a larger design or used to construct an entire integrated circuit (e.g., an SOC integrated circuit). A design facility 1130 can generate a software simulation 1110 of an IP core design in a high level programming language (e.g., C/C++). The software simulation 1110 can be used to design, test, and verify the behavior of the IP core. A register transfer level (RTL) design can then be created or synthesized from the simulation model 1112. The RTL design 1115 is an abstraction of the behavior of the integrated circuit that models the flow of digital signals between hardware registers, including the associated logic performed using the modeled digital signals. In addition to an RTL design 1115, lower-level designs at the logic level or transistor level may also be created, designed, or synthesized. Thus, the particular details of the initial design and simulation may vary.

The RTL design 1115 or equivalent may be further synthesized by the design facility into a hardware model 1120, which may be in a hardware description language (HDL), or some other representation of physical design data. The HDL may be further simulated or tested to verify the IP core design. The IP core design can be stored for delivery to a 3^{rd} party fabrication facility 1165 using non-volatile memory 1140 (e.g., hard disk, flash memory, or any non-volatile storage medium). Alternatively, the IP core design may be transmitted (e.g., via the Internet) over a wired connection 1150 or wireless connection 1160. The fabrication facility 1165 may then fabricate an integrated circuit that is based at least in part on the IP core design. The fabricated integrated circuit can be configured to perform operations in accordance with at least one embodiment described herein.

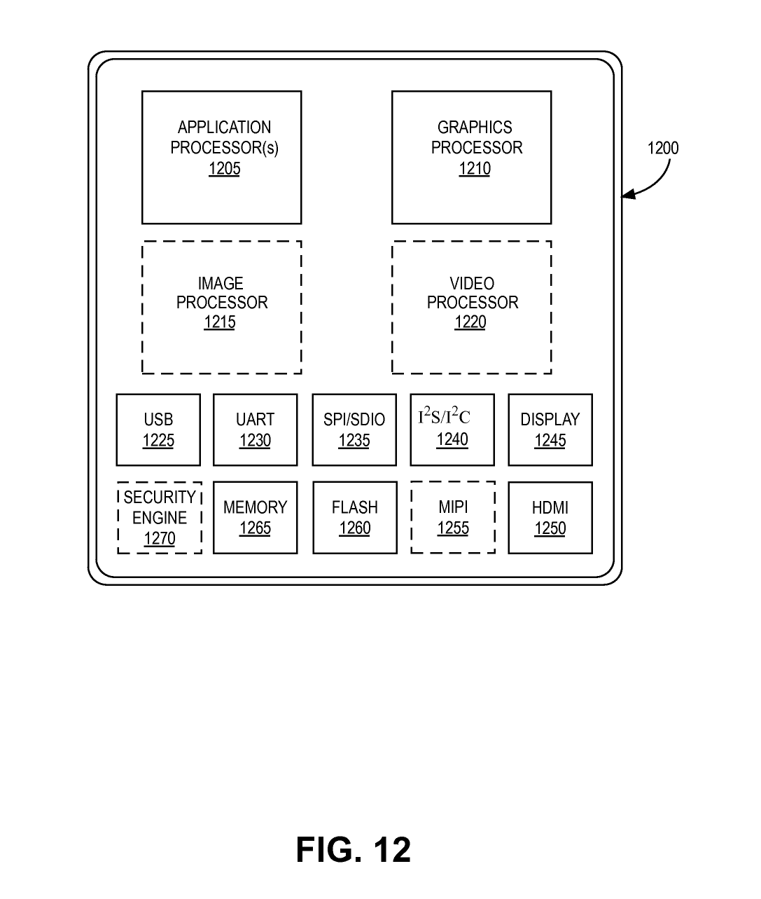

FIG. 12 is a block diagram illustrating an exemplary system on a chip integrated circuit 1200 that may be fabricated using one or more IP cores, according to an embodiment. The exemplary integrated circuit includes one or more application processors 1205 (e.g., CPUs), at least one graphics processor 1210, and may additionally include an image processor 1215 and/or a video processor 1220, any of which may be a modular IP core from the same or multiple different design facilities. The integrated circuit includes peripheral or bus logic including a USB controller 1225, UART controller 1230, an SPI/SDIO controller 1235, and an I²S/I²C controller 1240. Additionally, the integrated circuit can include a display device 1245 coupled to one or more of a high-definition multimedia interface (HDMI) controller 1250 and a mobile industry processor interface (MIPI) display interface 1255. Storage may be provided by a flash memory subsystem 1260 including flash memory and a flash memory controller. Memory interface may be provided via a memory controller 1265 for access to SDRAM or SRAM memory devices. Some integrated circuits additionally include an embedded security engine 1270.

Additionally, other logic and circuits may be included in the processor of integrated circuit 1200, including additional graphics processors/cores, peripheral interface controllers, or general-purpose processor cores.

### Color Transformation Using Non-Uniformly Sampled Multi-Dimensional Lookup Table

Uniform sampling of any series of data is suitable when the data varies uniformly. If the data changes rapidly in some regions than other regions, effective sampling logic will either take large number of samples or determine suitable sampling points to utilize the memory available for storing samples to optimally balance between accuracy and LUT size. In many practical designs intended for digital image processing and graphics, the LUT is stored in hardware registers and applied through hardware during pixel processing. In the hardware case, a large LUT can be very costly, as to effectively apply a large LUT, increased silicon area may be required. Values between LUT sample points are interpolated while applying the LUT. Linear interpolation is the simplest and hence more common.

In embodiments described herein a non-uniformly multi-dimensional lookup table is described which utilizes non-uniform sampling points for a given LUT memory budget. 3D LUTs for the RGB color model are used as examples, as the RGB color model is very common in display and graphics technology domains. However the general principle also works with N Dimensional LUTs with any other color model, such as the cyan, magenta, yellow, and key (CMYK) color model.

FIG. 13 illustrates an exemplary 3D lookup table 1300 that may be used for color transformation. Color transformation is often performed using a 3D look up table, as many color models use three primary colors. For example, color transformation with the RGB color model utilizes a 3D look up table, one dimension each for red, green, and blue components. When a pixel in RGB color model is encoded as eight bits per color, a full LUT will have 256×256×256 samples, where each sample is three bytes in size. Accordingly, a full LUT for 8-bit per channel RGB color will occupy 48 Megabytes of memory.

FIG. 14 illustrates an exemplary sampled 3D lookup table 1400 that may be used for color transformation. A sampled version of the full LUT may be used to optimize memory space consumed by the LUT and reduce the negative power implications of the large number of memory accesses performed when using a full LUT as in FIG. 13. Samples are taken at regular intervals and intermediate values can be interpolated at run time. The exemplary LUT 1400 shown is an 8³ LUT, having eight samples 1402 per color channel, for a total of 512 samples.

While an exemplary 8³ LUT is shown, 17 samples per color channel is commonly used in color transformation LUTs, resulting in 17×17×17 samples, or 4913 total samples. For LUTs using uniform sampling, the samples are spaced uniformly over the entire value range. For color values in the [0, 255] space, the samples will be taken at 0, 16, 32, 48, 64 . . . 255. Uniform sampling can provide good results when the data being sampled changes in a relatively uniform manner across the sampling positions.

However, in many practical cases the sample values may change sharply in certain regions, while change less sharply in other regions. To achieve good accuracy using uniform sampling, a large number of samples may be required, resulting in increased storage space for the LUT, as well as causing an increased number of memory read operations during color transformation due to the larger number of samples, which can negatively impact power and performance.

### Non-Uniform Sampling

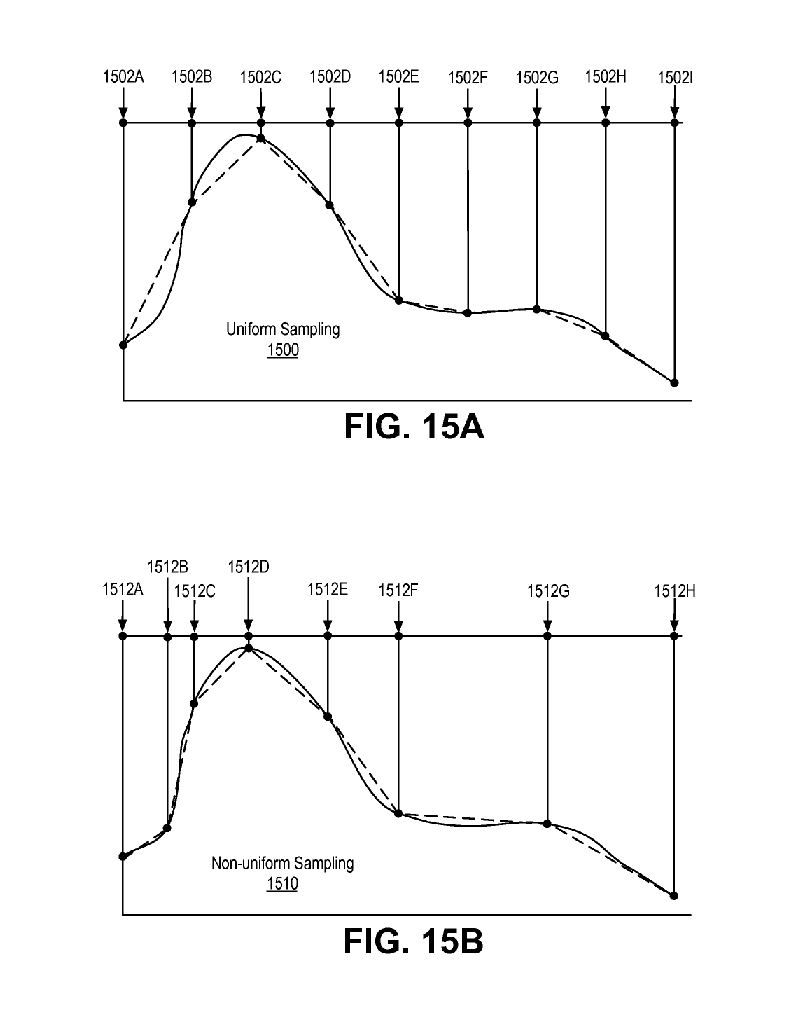

FIGS. 15A-B illustrates uniform and non-uniform sampling with respect to a one-dimensional lookup table. FIG. 15A illustrates uniform sampling 1500, in which a pre-determined number of samples are taken across a range of values, where each sample point is uniformly spaced. FIG. 15B illustrates non-uniform sampling 1510, in which the sample points are selected to be specific to the data that the samples are intended to represent. In general, the data contained in any LUT depends on the algorithm used to create the LUT data set. In some instances, the LUT may have significant non-linear variation within certain regions.

As shown in FIG. 15A, the sample points 1502A-I are arranged in uniformly spaced manner. The number and position of the sample points 1502A-I can be determined based upon the range of data to be sampled and the number of sample points to be used to sample the data. Uniform sampling 1500 can be beneficial and efficient when the data to be sampled varies somewhat uniformly across the sampled data set. However, where the data changes rapidly between the sample points, the sampled data set may begin to diverge significantly from the actual data set over certain sample regions. For example, a linearly interpolated value between sample point 1502A and sample point 1502B will be significantly less accurate than an interpolated value between sample point 1502F and sample point 1502G due to the non-uniform variation of the

FIG. 15B shows an example of non-uniform sampling 1510. Embodiments described herein provide for non-uniform sampling 1510 in regions of data where the data curvature is higher compared to flat regions of data. Such non-uniform sample positioning can reduce sample error significantly. With non-uniform sampling, the sample points 1512A-H are concentrated more heavily in regions where the curvature of the data is greater, for example, between sample point 1512A and sample point 1512D. A lower sample rate is used in regions experiencing a lower rate of change between sample points, such as between sample point 1512F and sample point 1512G. Non-uniform sampling techniques can be tested empirically against uniform sampling methods for a given data set. Additionally, tuning parameters for the non-uniform sampling techniques can be refined via software simulation.

While the exemplary sampling techniques shown in FIG. 15A-B represent methods of generating one-dimensional LUTs, the concepts are directly applicable to multi-dimensional LUTs. For example, a 3D LUT can be used to perform color correction or transformation in the sRGB color space.

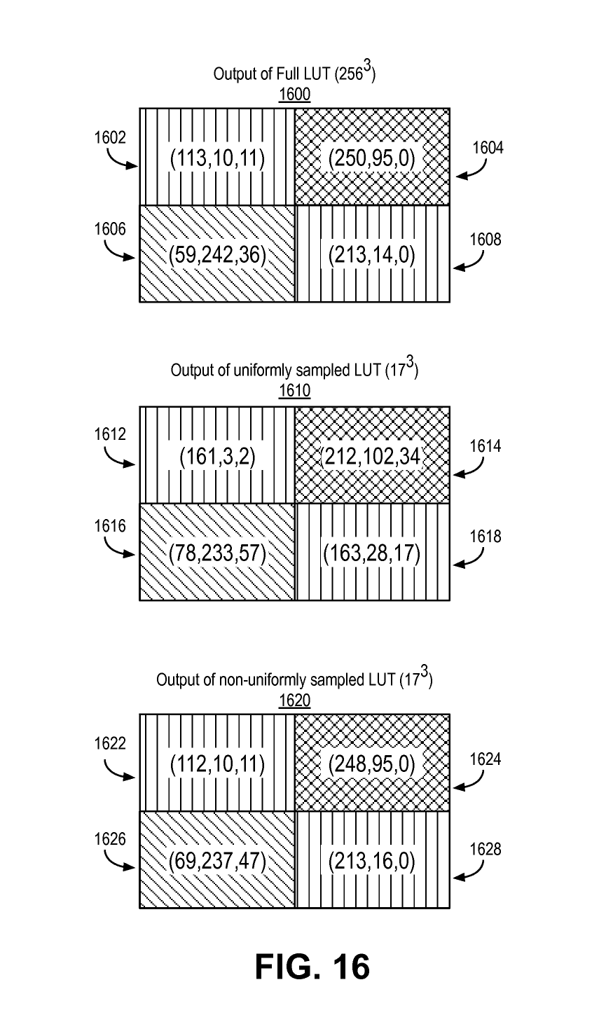

FIG. 16 illustrates exemplary transformations a three-channel color space. The three-channel color space can be a sRGB color space having a red, green, and blue channel, where the exemplary LUTs are used to perform color correction within the sRGB color space. However, transformations between differing color spaces may also be performed. The illustrated LUT outputs represent output in an 8-bit per channel sRGB color space, where each color channel can have a value between 0 and 255. The same input color data is transformed using differing LUTs.

First output data 1600 represents the output of a full LUT having 256 samples per channel, resulting in a one-to-one correspondence between sample points and available data to be sampled, where for each input color value, a corresponding output color value exists in the lookup table. For first output 1600, interpolation between sample points is not required. The first output 1600 includes exemplary transformed color data values of (Red 113, Green 10, Blue 11) 1602; (Red 250, Green 95, Blue 0) 1604; (Red 59, Green 242, Blue 36) 1606; (Red 213, Green 14, Blue 0) 1608.

Second output data 1610 represents the output of a uniformly sampled LUT having 17 samples per channel. The second output 1610 includes exemplary transformed color data values of (161,3,2) 1612; (212,102,34) 1614; (78,233,57) 1616; (163,28,17) 1618. While the uniformly sampled LUT used to generate the second output data 1610 occupies a significantly smaller amount of memory space relative to the full LUT used to generate the first output 1600, interpolation between the uniform sample points may result in increased error relative to the full LUT, depending on the degree of non-linear variation between the sample points. Accordingly, some degree of variation can be observed between the second output 1610 and the first output 1600, where the first output 1600 represents an accurate reflection of the output of the transformation algorithm used to perform the color transformation.

Third output data 1620 represents the output of a non-uniformly sampled LUT having 17 samples per channel. The third output 1620 includes exemplary transformed color data values of (112,10,11) 1622; (248,95,0) 1624; (69,237,47) 1626; (213,16,0) 1628. The third output data 1620 demonstrates that, for the exemplary input color values selected, the output of the non-uniformly sampled LUT more accurately reflects the output of the transformation algorithm (e.g., the full LUT) than the uniformly sampled LUT used to generate the second output 1610.

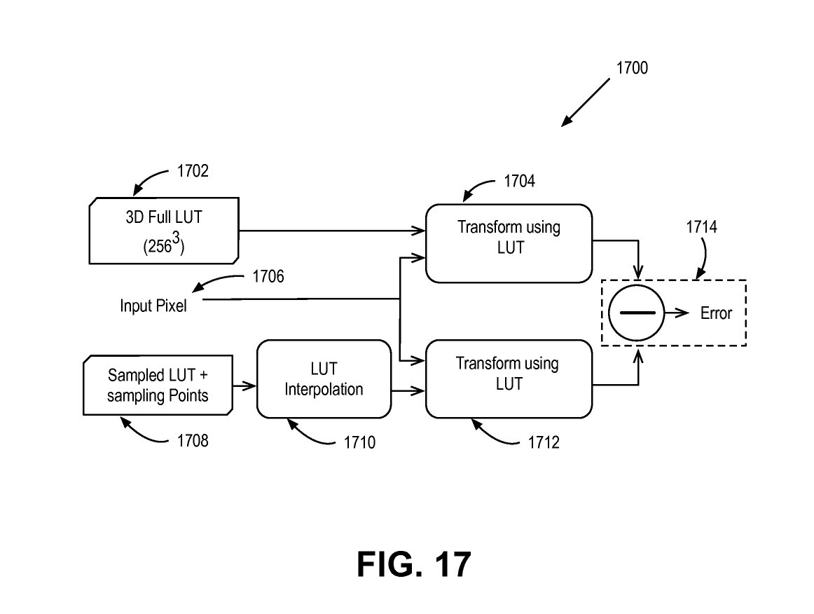

FIG. 17 is a block diagram illustrating a system 1700 for determining sampling error of a sampled LUT that may be used to refine techniques for LUT generation. The system 1700 accepts as input a three-dimensional full LUT 1702 for an 8-bit RGB color, an input pixel 1706, and a sampled LUT with accompanying sample points 1708. For uniformly sampled LUTs, the sample points can be computed dynamically based on the number of sample points. However, for non-uniformly sampled LUTs, the set of sample points is provided as input along with the LUT, as the sample points can be dynamically generated based on the algorithm used to create the LUT. The full LUT 1702 can be used to transform the input pixel 1706 at a first transformation stage 1704, in which the input pixel is transformed using the full LUT 1702. In one embodiment, prior to using the sampled LUT 1708, LUT interpolation 1710 can be performed to interpolate data values between the selected sample points, allowing an approximation of the full LUT 1702 to be generated at runtime without requiring the full set of sample data to be stored. A second transformation 1712 can then be performed using the sampled LUT. An error 1714 value can then be determined based on a difference between the output of the sampled LUT 1708 and the full LUT 1702.

The system 1700 of FIG. 17 can calculate, for all possible RGB pixel values in a 24-bits per pixel format (16M combinations in total) an error value for each color value after being processed by a sampled LUT and a full LUT. A comparison can be computed as shown in the Table 1 below.

TABLE 1
Uniformly and Non-Uniformly Sampled LUT Error Rates

| Uniform LUT Sampling | | | | Non-Uniform LUT Sampling | | | |
|---|---|---|---|---|---|---|---|
| | Number of | | | | Number of | | |
| | sampling | Max | Average | | sampling | Max | Average |
| LUT Size | points | Error | Error | LUT Size | points | Error | Error |
| 4913 | 51 | 19 | 1.204055 | 2925 | 43 | 20 | 1.242641 |
| 35937 | 99 | 19 | 1.026047 | 7920 | 60 | 8 | 1.04798 |
| 274625 | 195 | 17 | 0.942062 | 39672 | 103 | 5 | 0.944445 |

Table 1 shows a comparison between traditional uniformly sampled LUTs and the proposed non-uniformly sampled LUTs. The techniques described herein can be used to provide similar accuracy with a smaller LUT or can provide improved accuracy with similarly sized LUT. In one embodiment during color transformation, a partial saturation color transformation algorithm is used, which enables enhancement of situation of Green, Cyan, and Yellow pixels by up to 40%, while keeping Red, Green, and Magenta pixels unchanged.

The data shown in Table 1 is an exemplary comparison, and the error exhibited on a system can be largely dependent on the color-processing algorithm used to create the LUT. Where the color-processing algorithm creates data with significantly non-linear variation over certain regions, uniform LUT sampling will exhibit increased error.

In general, the uniform sampling scheme uses predefined sampling points uniformly distributed over the value range and those are same for all color components. For example a typical 17 point sampling scheme uses sampling points at values 0, 16, 32, 48 . . . 240, 255. As the points are predefined and at regular intervals, it may not be necessary to store the sample points for a uniformly sampled LUT. In one embodiment, for non-uniformly sampled LUTs, the sample points are stored along with the LUT, as the sample points are non-uniformly distributed and may vary based on the data being sampled to generate the LUT.

Sample points for a non-uniformly sampled LUT can be determined using a variety of techniques. In one embodiment, to determine optimal sampling points within the data generated by a color transformation algorithm, the color values can be considered as a set of Cartesian points in a three-dimensional space. Cartesian distances are computed between the pixels transformed using sampled LUT and full LUT. Sample points can then be positioned where the computed distance is greater than a threshold, which may be a pre-defined threshold or a dynamically computed threshold based on an accuracy and LUT size specification. Alternative methods of computing suitable sampling points can be used. For example, in one embodiment a three dimensional discrete Fourier transform can be performed on a full LUT and sampling points can be determined based on the Nyquist sampling principle.

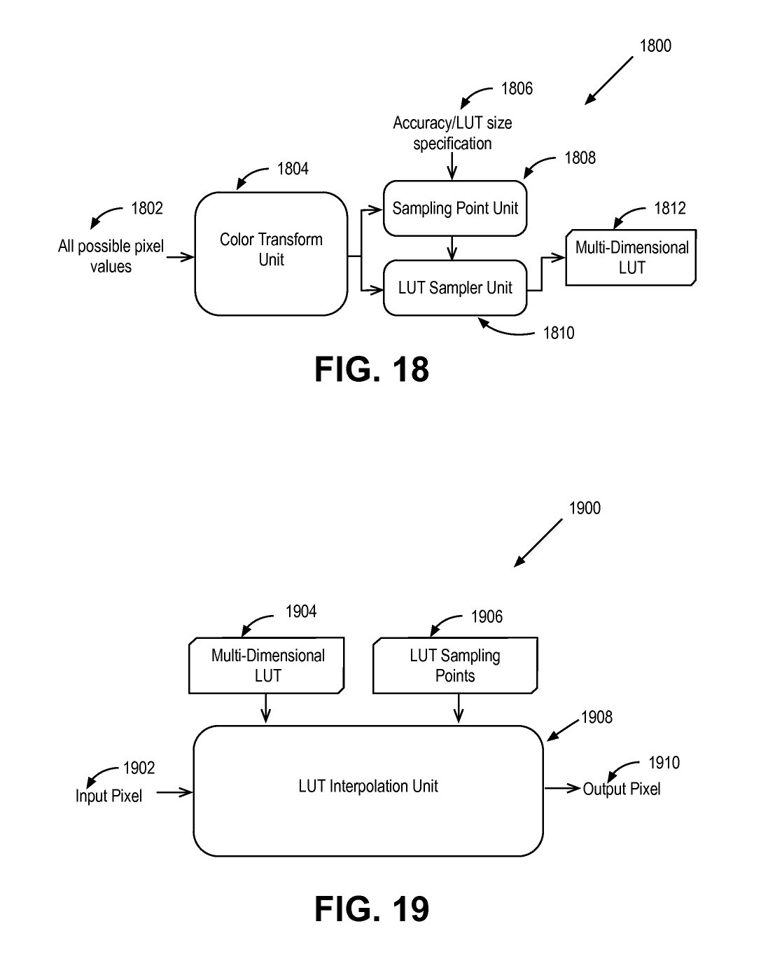

FIG. 18 is a block diagram of a system 1800 to generate a multi-dimensional lookup table 1812 using non-uniform sample points, according to an embodiment. The system 1800, in one embodiment, includes a color transform unit 1804 coupled to a sampling point unit 1808 and a LUT sampler unit 1810. The color transform unit 1804 can accept a set of pixel values, which may be all possible pixel values 1802 for a first color space and output transformed color values in a second color space. The transformed color values can be output to the sampling point unit 1808, which generates sample points for the LUT based on a rate of change across the color channels of the transformed color values based on a specified accuracy/LUT size specification 1806, which enables the number of sampling points to be tuned based on a set of accuracy and size parameters. The sampling point unit 1808 can determine a set of non-uniformly spaced samples based on the transformed color values in the second color space, for example using a version of the exemplary logic represented by the pseudo code of Table 3, a variant of which can be performed to determine sample points for each color channel. Using the sample points determined by the sampling point unit 1808, the LUT sampler unit 1810 can generate a multi-dimensional LUT 1812 by sampling the transformed color values in the second color space using the sample points selected for each channel of the first color space. In one embodiment the multi-dimensional LUT 1812 is stored along with the sampling points generated by the sampling point unit 1808. For a LUT having 39672 1-byte entries and 103 total sample points across all channels, the LUT will occupy (39672+103)=39775 Bytes of storage space. In one embodiment, graphics processing hardware includes additional register space for storing the sample positions generated by the sampling point unit 1808.

In one embodiment the second color space can be a transformed version of the first color space, for example, in an RGB to RGB transformation for color enhancement or other pixel post processing operations, such as ambient light based adaptive color correction. The second color space may also be a different color space from the first color space, such as in an sRGB to BT2020 YCbCr conversion performed, for example, during media encode, decode, or post processing operations.

FIG. 19 is a block diagram of a system 1900 for applying a non-uniformly sampled multi-dimensional LUT 1904 to pixel data, according to an embodiment. In one embodiment, while applying the multi-dimensional LUT 1904 at runtime, when an input pixel 1902 has color values that lie between individual sampling points of the LUT sampling points 1906, the color value for the output pixel 1910 is interpolated by a LUT interpolation unit 1908 based on transformed color data stored for nearby sample points. In one embodiment, a variant of linear interpolation (e.g., bi-linear, tri-linear) can be used based on the number of dimensions of the multi-dimensional LUT 1904. The specifics of the operation of the sampling point unit 1808, and LUT sampler unit 1810 of FIG. 18 and the LUT interpolation unit 1908 of FIG. 19 can vary across embodiments.

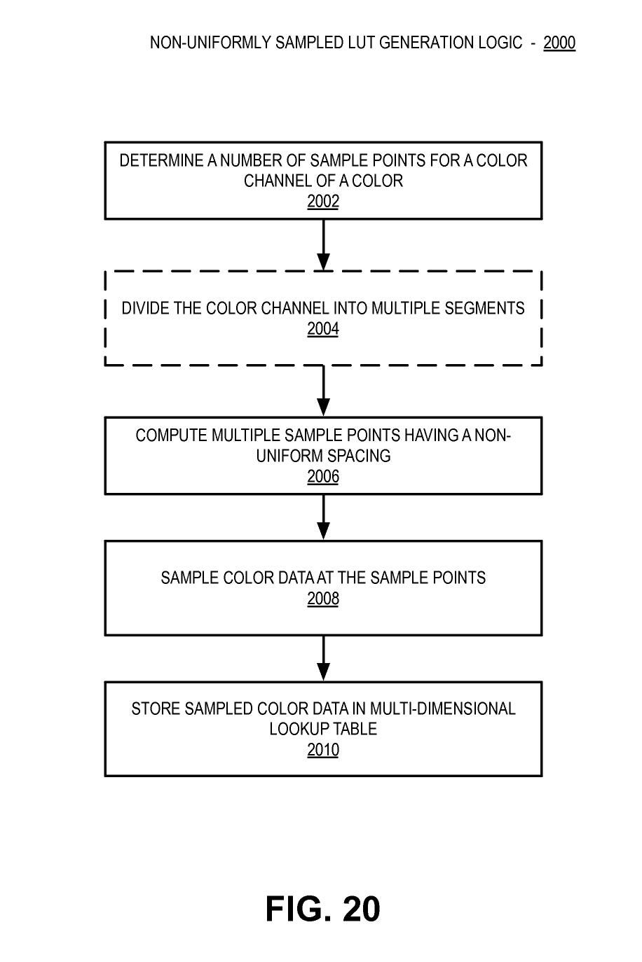

FIG. 20 is a flow diagram of exemplary non-uniformly sampled LUT generation logic 2000. In one embodiment the exemplary logic 2000 is performed by a combination of the sampling point unit 1808 and LUT sampler unit 1810 as in FIG. 18, which can include hardware and/or software logic (e.g., circuits, instructions, etc.) included within or associated with a graphics processing or computing apparatus, system, and/or device performs operations including to determine a number of sample points for a color channel of a color, as shown at block 2002. In one embodiment, the number of samples is a pre-determined number of samples for all color channels, while in one embodiment different color channels can have a different number of samples up to a pre-defined maximum number of samples.

In one embodiment the logic 2000 is further to divide the color channel into multiple segments, as shown at block 2004. In such embodiment, for a number of samples ‘N’, each axis is divided into (N-1) segments and a sampling position is determined for the segment. In one embodiment, one and only one sampling position is determined for each segment, where the position of the sample can vary within the segment. In one embodiment, the operation at block 2004 is optional and the logic 2000 performs non-segmented sample determination operations in which sampling positions can be selected at any location within a color channel.

As shown at block 2006, the logic can perform an operations to compute multiple sample points having non-uniform spacing, for example, by selecting a sample point within each segment after dividing the color channel into multiple segments at block 2004, or using a freeform sample determination method. The sample points can be stored in memory for use in sampling the color data at the sample points, shown at block 2008. In one embodiment, graphics-processing logic includes additional registers to store the computed sample points during runtime while performing color conversion. For example, one embodiment includes hardware support for a 3D LUT having 17 samples per color channel. In such embodiment, the graphics processing logic includes 17 additional 32-bit registers to store the 17×3 sampling points used for the LUT, where each register includes three 8-bit fields, allowing a single register to store a sample point for each of the three color channels of the 3D LUT.

After the sample points are determined, the logic 2000 can sample color data of the color channel at the computed sample points (e.g., via the LUT sampler unit 1810 of FIG. 18), as shown at block 2008. The logic 2000 can then store the sampled color data in a multi-dimensional lookup table (e.g., multi-dimensional LUT 1812 of FIG. 18), as shown at block 2010.

The generated multi-dimensional lookup table can be used by hardware or software logic to perform color transformation. In one embodiment, the graphics processor hardware modifications performed to take advantage of the non-uniformly sampled LUT are backwards compatible with uniform sampling, enabling legacy software to continue to use uniform sampling on hardware containing the enhancements described herein, while enhanced software can perform operations to calculate optimal sampling points depending on the use case and/or accuracy specifications for the sampled LUT. In one embodiment, optimal sampling points for a given dataset can be calculated or re-calculated at runtime. For example and in one embodiment, a complete set of non-uniform sampling positions for a 3D LUT can be calculated sufficiently rapidly for use cases such as ambient light based adaptive color correction, which may re-compute sampling positions based on a change in ambient light conditions.

### First Exemplary Sampling Technique

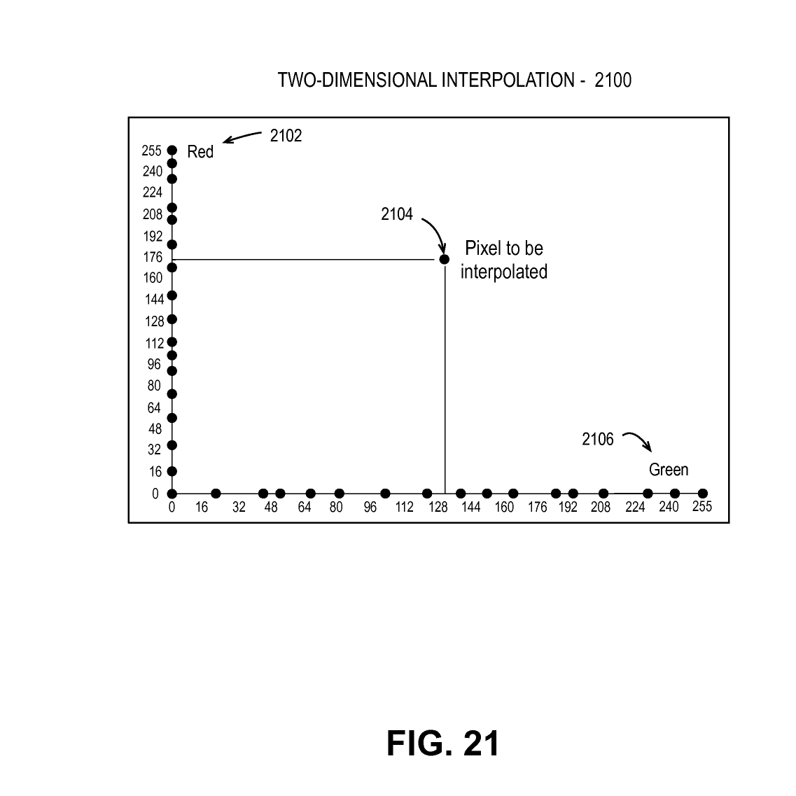

Several sampling techniques may be employed with non-uniform sampling. A first sampling technique is described in FIG. 21 and Table 2 below.

FIG. 21 is an illustration showing a representation of two-dimensional interpolation 2100 with an exemplary two-dimensional LUT. The exemplary two-dimensional LUT has a red channel 2102 and a green channel 2106, where each channel has 17 non-uniformly spaced samples. The samples can be determined using the segmented sample point determination technique described in FIG. 20, where an origin sample and one sample for each of 16 segments is determined for a first color space based on transformed color data in a second color space. In one embodiment, an input pixel 2104 has a color value that lies between the sample points. A LUT value can be interpolated for the pixel 2104 using the sample value nearest to the color value of the pixel 2104 for each channel. In one embodiment, a linear interpolation can be performed between two nearest sample points on each channel. In one embodiment, a bi-linear interpolation can be performed by applying successive one-dimensional linear interpolations for each of the red channel 2102 and green channel 2106.

While two-dimensional interpolation 2100 is illustrated, a similar interpolation technique can be used for three-dimensional or higher-dimensional LUTs, such as LUTs for a three-dimensional LUT for color translation within using RGB color model or a four-dimensional LUT for color translation using a CMYK color model. The exemplary logic of Table 2 demonstrates logic to find out the nearest sampling points in 3D space corresponding to a color pixel in an 8-bits per channel RGB color model. The nearest sample and the sample immediate next to it can be used to interpolate an intermediate value from the LUT.

TABLE 2
Exemplary logic to Map Pixel Color
Values to Nearest Sampling Points

#define MAX PIXEL VAL 255
typedef struct
{

USHORT IR;
USHORT IG;
USHORT IB;

}ColorRGB;
void ThreeDLutUtil::FindNearestLowerSamplingPoint(ColorRGB
*pSamplingPositions, DWORD nSamplesPerColor,
ColorRGB *pInPixel, ColorRGB *pIndex)
{

USHORT stepSize = (MAX_PIXEL_VAL + 1) /
(nSamplesPerColor − 1);
USHORT r = pInPixel−>IR, g = pInPixel−>IG, b =
pInPixel−>IB;
// Manipulate max value to map max value to the last sampling point
if (r == MAX_PIXEL_VAL) r == (MAX_PIXEL_VAL + 1);
if (g == MAX_PIXEL_VAL) g == (MAX_PIXEL_VAL + 1);
if (b == MAX_PIXEL_VAL) b == (MAX_PIXEL_VAL + 1);
pIndex−>IR = r / stepSize;
pIndex−>IG = g / stepSize;
pIndex−>IB = b / stepSize;
// Interpolated position is below the assumed sampling position
calculated from stepsize.
// Hence actual sampling position will be one sample behind.
if (pInPixel−>IR < pSamplingPositions[pIndex−>IR].IR &&
pindex−>IR > 0) pindex−>IR−−;
if (pinPixel−>IG < pSamplingPositions[pindex−>IG].IG &&
pIndex−>IG > 0) pIndex−>IG−−;
if (pinPixel−>IB < pSamplingPositions[pindex−>IB].IB &&
pIndex−>IB > 0) pindex−>IB−−;
// Interpolated position is above the assumed sampling position
calculated from stepsize.
// Hence actual sampling position will be one sample after.
if (pIndex−>IR<(nSamplesPerColor−1) &&
pinPixel−>IR >=pSamplingPositions[pindex−>IR+1].IR)
pIndex−>IR++;
if (p!ndex−>IG<(nSamplesPerColor−1) &&
pinPixel−>IG >=pSamplingPositions[pIndex−>IG+1).IG)
pIndex −>IG++;
if (pindex−>IB<(nSamplesPerColor−1) && pInPixel−>IB >=
pSamplingPositions[p!ndex−>IB + 1].IB) pIndex −>IB++;

}

The logic of Table 2 can be used to determine if an interpolated position for a set of non-uniform samples is below the assumed sampling position or above the assumed sampling position relative to a stepsize. In this example, the step size is defined as the maximum pixel value plus one, divided by the number of samples per color channel −1 (e.g., (MAX_PIXEL_VAL+1)! (nSamplesPerColor−1)). For a color space having 8-bits per channel, when using 17 samples per color, the step size is 16. This sample scheme is represented in FIG. 21, which illustrates a sample placed deterministically within each 16-unit segment between the axis origin and the maximum color value.

### Second Exemplary Sampling Technique

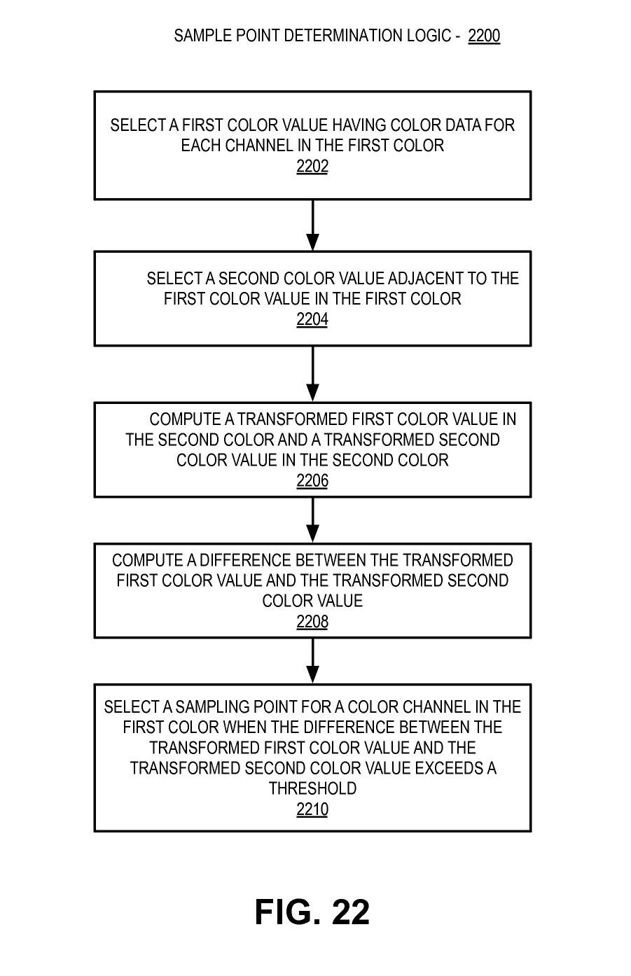

A second sampling technique is described in FIG. 22 and Table 3 below. In additional to the first exemplary sampling technique described above and the second exemplary sampling technique described below, other sampling techniques may also be employed.

FIG. 22 is a flow diagram of sample point determination logic 2200, according to an embodiment. In one embodiment, sample points for each channel can be computed at runtime by the sample point determination logic, although sample points may be pre-computed and stored with the LUT. In one embodiment, the sampling point unit 1808 of FIG. 18 can perform the sample point determination logic 2200, which can be configured to perform operations including to select a first color value having color data for each channel in the first color, as shown at block 2202.

The logic 2200 can additionally perform operations to select a second color value adjacent to the first color value in the first color, as shown at block 2204. In one embodiment, using the color transformation unit, the logic 2200 can compute a transformed first color value in the second color and a transformed second color value in the second color, as shown at block 2206. In one embodiment, the logic 2200 can compute a difference between the transformed first color value and the transformed second color value, as shown at block 2208.

Using the difference value determined at block 2208, the logic 2200 can select a sampling point for a color channel in the first color when the difference between the transformed first color value and the transformed second color value exceeds a threshold, as shown at block 2210. The threshold can be configured based on accuracy/LUT size specification, such as the accuracy/LUT size specification 1806 specified for the sampling point unit 1808, as shown in FIG. 18.

As an example of the sample point determination logic 2200 of FIG. 22, exemplary logic to compute sample points for a red color channel of an sRGB color space is shown in Table 3 below. In Table 3, the sample points for the red color channel are computed based on the possible translated color values in the green and blue channels. Whether to place a sample point is adjustable based on a configured threshold value.

TABLE 3
Exemplary logic to Compute Sample Points for a Color Channel

UINT32 DistanceThreshold = 10;
// Actual value depends on algorithm, use case and desired accuracy
UINT32 Distance;
for(RedVal = 1; RedVal < 256; RedVal ++)
{

for(GreenVal = 0; GreenVal < 256; GreenVal ++)
{

for(BlueVal = 0; BlueVal < 256; BlueVal ++)

{

CurrentPixel = {RedVal, GreenVal, BlueVal };
PreviousPixel = {( RedVal − 1), GreenVal, BlueVal };
TransCurrentPixel =
ColorTransformationAlgorithm(CurrentPixel)
TransPreviousPixel =
ColorTransformationAlgorithm(PreviousPixel)
Distance = [(TransCurrentPixel.RedVal −
TransPreviousPixel.RedVal)² +

(TransCurrentPixel.GreenVal −
TransPreviousPixel.GreenVal)² +
(TransCurrentPixel.BlueVal −
TransPreviousPixel.BlueVal)²]^{0.5}
if(Distance > DistanceThreshold)
{

RedSamplingPoint = RedVal;

}

}

}

}

The exemplary logic represented by the pseudo code of Table 3 can be performed for each color channel. A color value for a pixel can be expressed by N components, where N is three for tri-stimulus (e.g., RGB) color models. Each component will have M possible values of each color component, where M is 256 for color systems having 8-bits per color channel. In one embodiment, the sampling points are determined independently for each color channel. A set of sampling points for a color channel can be determined by iterating, for each color value in the color channel, through each set of color value in the corresponding channels and computing a distance (e.g., difference) between transformed color values of transformed values in adjacent positions of the LUT.

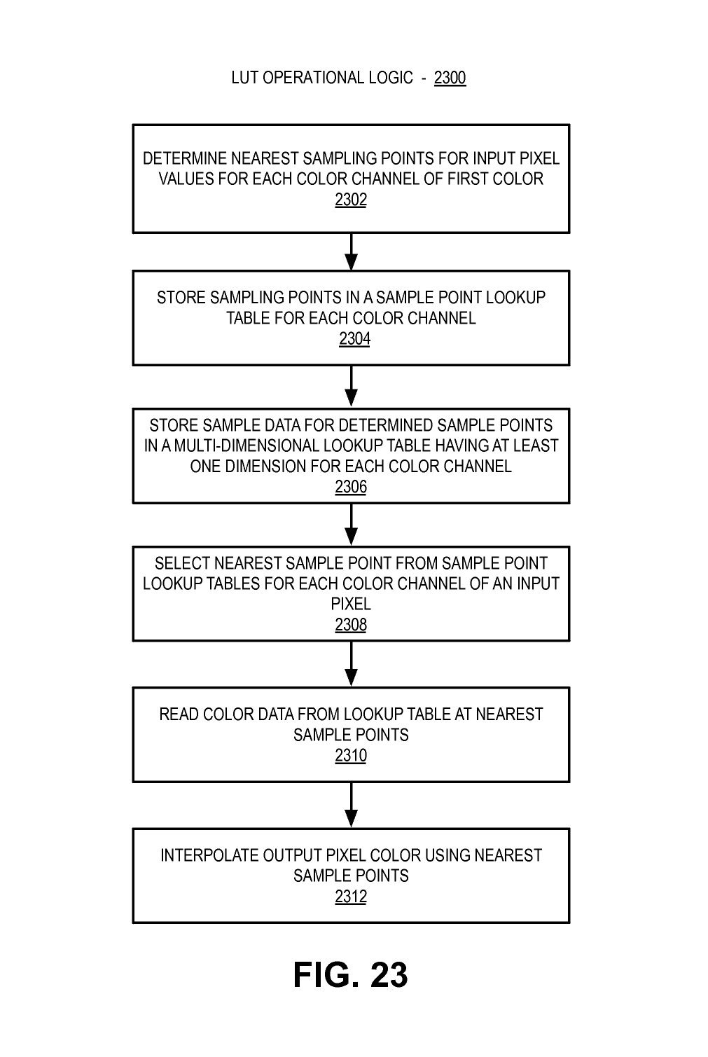

FIG. 23 is a flow diagram of LUT operational logic 2300, according to an embodiment. In one embodiment, the LUT operational logic 2300 is performed in part by software executing on a general-purpose processor, such as the processor(s) 102 of FIG. 1 or processor 200 of FIG. 2. In one embodiment the logic 2300 is performed at least in part by the LUT interpolation unit 1908 of FIG. 19, which may reside, for example, within the exemplary graphics processor 208 of FIG. 2, or any other graphics processing device described herein.

In one embodiment, the LUT operational logic 2300 performs operations including to determine the nearest sampling points for input pixel values for each color channel of a first color, as shown at block 2302, where the first color corresponds with the color of the input pixels. In such embodiment, each color channel can have a different number of samples within a pre-determined maximum value and the sample positions can be located at any point along a color axis corresponding with the color channel. In one embodiment, the logic 2300 is further to perform operations including to store the sampling points in a sample point lookup table for each color channel, as shown at block 2304.

In one embodiment, the sampling point lookup tables are separate LUTs for each color channel. For example, for an RGB color LUT having three-color channels, three one-dimensional LUTs can be used to store the separate sets of sample points for each color channel. In one embodiment, the three one-dimensional LUTs can be programmed to hardware and stored in register space. The three one-dimensional LUTs can then be used to address a multi-dimensional LUT stored in memory. In one embodiment, for three color channels, hardware includes additional register space for storing 3*M number of sampling positions, where M is the total number of values possible for a color. For example, on a system configured for RGB color at 10-bits per color channel, each color channel can have up to 1024 colors. Accordingly, the system can be configured to store 3×1024 sampling positions in sample position registers in addition to the color data for the 3D LUT. In one embodiment, as shown at block 2306, the logic 2300 can perform operations to store sampled data associated with the determined nearest sampling points to a multi-dimensional lookup table having at least one dimension for each color channel.

In one embodiment, during operation, the logic 2300 can select the nearest sample from the sample point lookup tables for each color channel of an input pixel, as shown at block 2308. In one embodiment, the LUT operational logic 2300 can configure graphics processor hardware logic can be used to address the multi-dimensional LUT based on the sample point lookup tables stored in the hardware registers. In such embodiment, the hardware logic can be configured to read color data from the lookup table at the nearest sample points, as shown at block 2310. The hardware logic can then interpolate an output pixel color using the nearest sampling points, as shown at block 2312. In general, the LUT operational logic 2300 of FIG. 23 can be used where a larger amount of sample flexibility is desired in exchange for the use of a larger amount of register space in hardware.

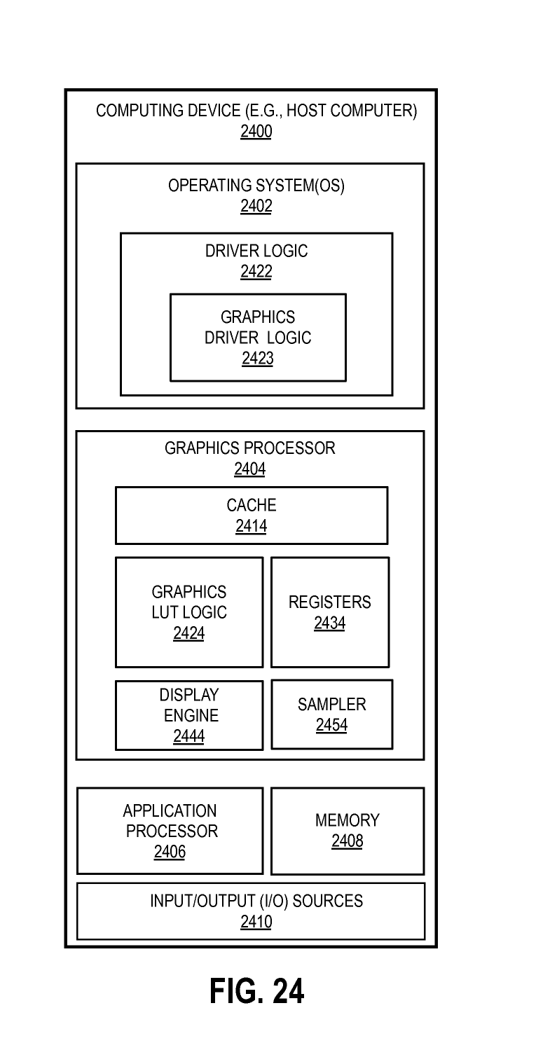

FIG. 24 is a block diagram of a computing device 2400 configured to perform color transformation using non-uniformly sampled multi-dimensional lookup table, according to an embodiment. The computing device 2400 can be a variant of the data processing system 100 of FIG. 1, including a mobile computing device, desktop computer, server device, smartphone, tablet computer, laptop, game console, portable workstation, or any other computing device that can serve as a host machine for a graphics processor 2404. In one embodiment, the computing device 2400 includes a mobile computing device employing an integrated circuit (“IC”), such as system on a chip (“SoC” or “SOC”), integrating various hardware and/or software components of computing device 2400 on a single chip.

In one embodiment, the graphics processor 2404 includes a display engine 2444 and a sampler 2454, where the display engine is configured to display frame buffer or other render target memory, and can include logic to perform runtime color transformation of display memory. In one embodiment, the display controller 2444 is a variant of the display controller 302 of FIG. 3 and/or the display engine 840 of FIG. 4. The sampler 2454, in one embodiment, is a variant of the sampler 854 of FIG. 8, and can sample data from frame buffer, render target, texture memory, or memory storing media information. In one embodiment, the sampler 2454 can be used in part to address a color transform lookup table in memory while performing lookup table operations using the graphics processor 2404.

As illustrated, in one embodiment, in addition to a graphics processor 2404 employing, the computing device 2400 may further include any number and type of hardware components and/or software components, such as (but not limited to) an application processor 2406, memory 2408, and input/output (I/O) sources 2410. The application processor 2406 can interact with a hardware graphics pipeline, as illustrated with reference to FIG. 3, to share graphics pipelining functionality. Processed data is stored in a buffer in the hardware graphics pipeline, and state information is stored in memory 2408. The resulting image is then transferred to a display component or device, such as display device 320 of FIG. 3, for displaying. It is contemplated that the display device may be of various types, such as Cathode Ray Tube (CRT), Thin Film Transistor (TFT), Liquid Crystal Display (LCD), Organic Light Emitting Diode (OLED) array, etc., to display information to a user.

The application processor 2406 can include one or processors, such as processor(s) 102 of FIG. 1, and may be the central processing unit (CPU) that is used at least in part to execute an operating system (OS) 2402 for the computing device 2402. The OS 2402 can serve as an interface between hardware and/or physical resources of the computer device 2400 and a user. The OS 2402 can include driver logic 2422 including graphics driver logic 2423, which includes the user mode graphics driver 1026 and/or kernel mode graphics driver 1029 of FIG. 10. The graphics driver logic 2423 can include software logic to configure operations utilizing the graphics LUT logic 2424 of the graphics processor 2404. The graphics LUT logic 2424 includes, but is not limited to components to perform, at least in part, the operations of the color transform unit 1804, sampling point unit 1806, and LUT sampler unit 1810 of FIG. 18 and the LUT interpolation unit 1908 of FIG. 19. However, in some embodiments, one or more of the operations of the included units can be performed by software logic executing on the application processor 2406. Additionally, the graphics processor 2404 includes a cache 2414 memory and a set of registers 2434 to store data for performing graphics operations, including LUT sampling points 1906 and in one embodiment, at least a portion of the multi-dimensional LUT 1904, each of FIG. 19.

It is contemplated that in some embodiments, the graphics processor 2404 may exist as part of the application processor 2406 (such as part of a physical CPU package) in which case, at least a portion of the memory 2408 may be shared by the application processor 2406 and graphics processor 2404, although at least a portion of the memory 2408 may be exclusive to the graphics processor 2404, or the graphics processor 2404 may have a separate store of memory. The memory 2408 may comprise a pre-allocated region of a buffer (e.g., framebuffer). However, embodiments are not so limited, and that any memory accessible to the lower graphics pipeline may be used. The memory 2408 may include various forms of random access memory (RAM) (e.g., SDRAM, SRAM, etc.) comprising an application that makes use of the graphics processor 2404 to render a desktop or 3D graphics scene. A memory controller hub, such as memory controller hub 116 of FIG. 1, may access data in the RAM and forward it to graphics processor 2404 for graphics pipeline processing. The memory 2408 may be made available to other components within the computing device 2400. For example, any data (e.g., input graphics data) received from various I/O sources 2410 of the computing device 2400 can be temporarily queued into memory 2408 prior to their being operated upon by one or more processor(s) (e.g., application processor 2406) in the implementation of a software program or application. Similarly, data that a software program determines should be sent from the computing device 2400 to an outside entity through one of the computing system interfaces, or stored into an internal storage element, is often temporarily queued in memory 2408 prior to its being transmitted or stored.

The I/O sources can include devices such as touchscreens, touch panels, touch pads, virtual or regular keyboards, virtual or regular mice, ports, connectors, network devices, or the like, and can attach via an input/output (I/O) control hub (ICH) 130 as referenced in FIG. 1. Additionally, the I/O sources 2410 may include one or more I/O devices that are implemented for transferring data to and/or from the computing device 2400 (e.g., a networking adapter); or, for a large-scale non-volatile storage within the computing device 2400 (e.g., hard disk drive). User input devices, including alphanumeric and other keys, may be used to communicate information and command selections to graphics processor 2404. Another type of user input device is cursor control, such as a mouse, a trackball, a touchscreen, a touchpad, or cursor direction keys to communicate direction information and command selections to the graphics processor 2404, and to control cursor movement on the display device. Camera and microphone arrays (not shown) may also be employed to observe gestures, record audio and video and to receive and transmit visual and audio commands.

I/O sources 2410 configured as network interfaces can provide access to a network, such as a LAN, a wide area network (WAN), a metropolitan area network (MAN), a personal area network (PAN), Bluetooth, a cloud network, a cellular or mobile network (e.g., 3^{rd} Generation (3G), 4^{th} Generation (4G), etc.), an intranet, the Internet, etc. Network interface(s) may include, for example, a wireless network interface having one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Network interface(s) may provide access to a LAN, for example, by conforming to IEEE 802.11 standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface(s) may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

It is to be appreciated that a lesser or more equipped system than the example described above may be preferred for certain implementations. Therefore, the configuration of the computing device 2400 may vary from implementation to implementation depending upon numerous factors, such as price constraints, performance requirements, technological improvements, or other circumstances. Examples include (without limitation) a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any one or a combination of: one or more microchips or integrated circuits interconnected using a backplane or mainboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

In the disclosure above, embodiments are described which provide for a graphics processing apparatus comprising a graphics processing unit including color transformation logic to convert from a first color to a second color using a non-uniformly sampled multi-dimensional lookup table. In one embodiment, the graphics processing logic additionally includes lookup table generation logic to generate the non-uniformly sampled multi-dimensional lookup table, where the lookup table logic includes a color transform unit to transform color data for a pixel from the first color to the second color, a sampling point unit to compute a set of non-uniform sampling points in the first color, and a lookup table sampler unit to generate the multi-dimensional lookup table for the second color using the non-uniform sampling points in the first color.

A further embodiment provides for a non-transitory machine-readable medium storing data which, when executed by one or more machines, cause the one or more machines to manufacture an integrated circuit to perform operations of a method comprising determining a number of sample points for a color channel of a color, dividing the color channel into multiple segments, computing multiple sample points within the segments, the sample points for the segments having a non-uniform spacing, sampling color data of the color channel at the sample points, and storing the sampled color data into the lookup table, wherein the lookup table is a non-uniformly sampled multi-dimensional lookup table, each dimension corresponding to a color channel.

A further embodiment provides for a graphics processing system comprising a color transform unit to transform color data for a pixel from a first color to a second color, a sampling point unit to compute a set of non-uniform sampling points in the second color, and a lookup table interpolation unit to generate color data for an output pixel based on the color data for an input pixel via a multi-dimensional lookup table.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A graphics processing apparatus comprising:
a graphics processing unit including color conversion logic to convert from a first color to a second color using a non-uniformly sampled multi-dimensional lookup table.

2. The apparatus as in claim 1, additionally comprising lookup table generation logic to generate the non-uniformly sampled multi-dimensional lookup table

3. The apparatus as in claim 2, wherein the lookup table generation logic includes:
a color transform unit to transform color data for a pixel from the first color to the second color;
a sampling point unit to compute a set of non-uniformly distributed sampling points in the first color; and
a lookup table sampler unit to generate the multi-dimensional lookup table for the second color using the non-uniform sampling points in the first color.

4. The apparatus as in claim 3, additionally comprising:
a first set of registers to store color data for the lookup table; and
a second set of registers to store sample points for the color data.

5. The apparatus as in claim 4, wherein each register in the second set of registers stores samples from multiple dimensions of the lookup table.

6. The apparatus as in claim 1, wherein the multi-dimensional lookup table includes at least one dimension per color channel of the first color.

7. The apparatus as in claim 1, wherein the first color is in a first color space and the second color is in a second color space.

8. The apparatus as in claim 7, wherein the first color space is an RGB based color space.

9. The apparatus as in claim 7, wherein the second color space is an RGB based color space.

10. A non-transitory machine-readable medium storing data which, when executed by one or more machines, cause the one or more machines to manufacture an integrated circuit to perform operations of a method comprising:
determining a number of sample points for a color channel of a color;
dividing the color channel into multiple segments;
computing multiple sample points within the multiple segments, the sample points for the multiple segments having a non-uniform spacing;
sampling color data of the color channel at the sample points; and
storing the sampled color data into the lookup table, wherein the lookup table is a non-uniformly sampled multi-dimensional lookup table, each dimension corresponding to a color channel.

11. The medium as in claim 10, the method further comprising computing sample points for each color channel of the color based on a distance between color values in the color, wherein a sample point is computed when the distance between color values exceeds a threshold.

12. The medium as in claim 11, wherein the color is a transformed color and the distance between color values in the transformed color is based on a difference between a color values for multiple channels of the transformed color.

13. The medium as in claim 11, wherein the threshold is tunable based on specified lookup table accuracy relative to lookup table size.

14. A graphics processing system comprising:
a color transform unit to transform color data for a pixel from a first color to a second color;
a sampling point unit to compute a set of non-uniform sampling points in the second color; and
a lookup table interpolation unit to generate color data for an output pixel based on the color data for an input pixel via a multi-dimensional lookup table.

15. The system as in claim 14, further comprising a lookup table sampler unit to generate the multi-dimensional lookup table using the non-uniform sampling points.

16. The system as in claim 14, wherein the color data for the input pixel is between multiple sampling points and the lookup table interpolation unit is further to interpolate the color data for the output pixel based on data in the multi-dimensional lookup table using the multiple non-uniform sampling points.

17. The system as in claim 16, wherein the lookup table interpolation unit is to linearly interpolate the color data for the output pixel.

18. The system as in claim 14, wherein the sampling point unit is to compute sample points for each color channel of the second color based on a distance between color values in the second color.

19. The system as in claim 18, wherein the sampling point unit is further to:
select a first color value having color data for each channel in the first color;
select a second color value adjacent to the first color value in the first color;
using the color transformation unit, compute a transformed first color value in the second color and a transformed second color value in the second color;
compute a difference between the transformed first color value and the transformed second color value; and
select a sampling point for a color channel in the first color when the difference between the transformed first color value and the transformed second color value exceeds a threshold.

20. The system as in claim 19, wherein the sampling point unit is further to determine the difference between the transformed first color value and the transformed second color value based on values for multiple color channels.
